(19) United States
(12) Patent Application Publication
(10) Pub. No.: US 2026/0197368 A1
(43) Pub. Date: Jul. 9, 2026

(54) FIRST NODE, SECOND NODE, THIRD NODE, DEVICE, AND METHODS PERFORMED THEREBY FOR HANDLING PROVISION OF CONTENT TOWARDS A USER

(71) Applicant: Telefonaktiebolaget LM Ericsson (publ), Stockholm (SE)

(72) Inventors: Rodrigo ALVAREZ DOMINGUEZ, Madrid (ES); Miguel Angel MUÑOZ DE LA TORRE ALONSO, Madrid (ES)

(21) Appl. No.: 19/129,721

(22) PCT Filed: Dec. 16, 2022
(86) PCT No.: PCT/EP2022/086327

§ 371 Date: May 14, 2025

(30) Foreign Application Priority Data
Dec. 5, 2022 (EP) 22383187.6

(51) Int. Cl. H04L 67/12

(52) U.S. Cl. CPC H04L 67/12

(57) ABSTRACT

A computer-implemented method, performed by a first node. The method is for handling provision of content towards a user. The first node operates in a communications system. The first node obtains a first indication from a second node operating via the communications system. The first indication indicates a request to provide a location of the content for delivery to the user of a device operating via the communications system. The content is included in a third node accessible via the communications system. The content is configured to provide a stimulus of a sense, catalogued as such in the third node, to the user of the device. The first node also initiates, responsive to the obtained first indication, providing the content towards the user of the device via a fourth node.

### TECHNICAL FIELD

The present disclosure relates generally to a first node and methods performed thereby for handling provision of content towards a user. The present disclosure also relates generally to a second node, and methods performed thereby for handling the provision of the content towards the user. The present disclosure further relates generally to a third node, and methods performed thereby for handling the provision of the content towards the user. The present disclosure additionally relates generally to a device, and methods performed thereby for handling the provision of the content towards the user.

### BACKGROUND

Computer systems in a communications network or communications system may comprise one or more nodes. A node may comprise a processing circuitry which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. The AF 1 may allow external parties to use the Exposure Application Program Interfaces (APIs) offered by the Mobile Network Operator (MNO). In case the AF may be trusted, e.g., internal to the network operator, the AF may interact with the 3GPP Core Network directly, with no NEF involved. The NEF 2 may support different functionality, e.g., different Exposure APIs, e.g., sponsored Data, Quality of Service (QoS), etc., which may allow a content provider to request policies from the MNO. The NEF 2 may be understood to act as the entry point into the network of the operator, so an external AF, e.g., a content provider, may interact with the 3GPP Core Network through the NEF 2.

A Unified Data Repository (UDR), which is not depicted, may store data grouped into distinct collections of subscription-related information: subscription data, policy data, structured data for exposure, and application data. A Unified Data Management Function (UDM) 3 may generate 3GPP 5G AKA Authentication Vectors, handle user identification handling, support a UE's Serving Network Function (NF) Registration Management, e.g., storing the serving Access and Mobility Function (AMF) for a UE, storing the serving Session Management Function (SMF) for a UE's Protocol Data Unit (PDU) Session, etc., support retrieval of the UE's individual subscription data for slice selection, and handle subscription data for network exposure capabilities applicable to an individual UE or a group of UEs. A Policy Control Function (PCF) 4 may support a unified policy framework to govern the network behavior. Specifically, the PCF 4 may provide Policy and Charging Control (PCC) rules to an SMF 5/User Plane function (UPF) 6 that may enforce policy and charging decisions according to provisioned Policy and Charging Control (PCC) rules. The SMF 5 may support different functionalities, e.g., session establishment, modify and release, and policy related functionalities such as termination of interfaces towards policy control functions, charging data collection, support of charging interfaces and control and coordination of charging data collection at the UPF 6. Specifically, the SMF 5 may configure the UPF 6, e.g., for event reporting accordingly through an N4 7 reference point, Packet Flow Control Protocol (PFCP) protocol. The UPF 6 may support handling of user plane traffic based on the rules received from the SMF 5, e.g., packet inspection through Packet Detection Rules (PDRs) and different enforcement actions such as, e.g., event detection and reporting. The PCF 4 may provide policy rules to a UE 8 through the AMF 9. The AMF 9 may manage access of the UE 8, for example, when the UE 8 may be connected through different access networks, and mobility aspects of the UE 8. Also depicted in FIG. 1 is a Network Slice Selection Function (NSSF) 10, Network Repository Function (NRF) 11, an Authentication Server Function (AUSF) 12, a Radio Access Network (RAN) 13, and a Data Network (DN) 14. Each of the NSSF 10, the NEF 2, the NRF 11, the PCF 4, the UDM 3, the AF 1, the AUSF 12, the AMF 9, the SMF 5, the UE 8, the RAN 13, the UPF 6 and the DN 14 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23, N1 24, and N2 25. The RAN 13 may have an interface N3 26 with the UPF 6, and the UPF 6 may have an interface N6 27 with the DN 14.

### 3GPP Exposure Framework

3GPP has defined a framework for Exposure. Specifically, there may be a northbound interface between the content provider, e.g., the AF, and the network operator, e.g., the NEF, supporting a set of APIs, e.g., QoS, Sponsored Data, etc.

### Internet of Senses

Digital scent technology, or olfactory technology, may be understood as an engineering discipline dealing with olfactory representation. It may be understood as a technology to sense, transmit and receive scent-enabled digital media, such as web pages, video games, movies and music. The sensing part of this technology may work by using olfactometers and electronic noses.

The Tactile Internet may enable haptic interaction with visual feedback. The term haptic may be understood to relate to the sense of touch, in particular the perception and manipulation of objects using touch and proprioception. Proprioception may be understood as the sense of the relative positioning of the parts of one's body and the strength of effort used in movement.

In this new era of Internet of Senses (IoS), content providers may include sense related media from sense providers, other than audio and video, in their applications. The applications may be, for example, applications in the medical field, and hence this function may be of great value to users.

Existing methods, however, may lead to an incorrect and/or ineffective delivery of IoS content towards users.

### SUMMARY

As part of the development of embodiments herein, one or more challenges with the existing technology will first be identified and discussed.

Some users may have some disabilities in their senses. For example, if the disability is in the sense of smell, the user may suffer from hyposmia, a reduced ability to smell and to detect odors, anosmia, the condition of having no sense of smell or being unable to smell certain things, parosmia, changes to the sense of smell that make things smell different from usual, and/or from phantosmia, a condition that causes a user to smell odors that are not actually present. If the disability is in the sense of touch, the user may suffer from hypoaesthesia that is, a partial or total loss of sensation in a part of his or her body.

Content providers may be interested in providing sense stimulation such as smell or touch to users, such as those having a disability.

Additionally, content providers may be interested in improving how end users perceive their content.

However, content providers are not aware of whether the end users are able to consume the sense related media provided. That is, they do not have a way, under existing methods, of checking that the correct IoS content was correctly delivered to a user, and/or how to provide the IoS content through the network of an MNO.

Embodiments herein may be understood to provide a mechanism which may solve the above problems and that may be based on defining a new procedure to test sense related media/content.

According to the foregoing, it is an object of embodiments herein to improve the handling of provision of content towards a user in a communications system.

According to a first aspect of embodiments herein, the object is achieved by a computer-implemented method, performed by a first node. The method is for handling provision of content towards a user. The first node operates in the communications system. The first node obtains a first indication from a second node. The second node operates via the communications system. The first indication indicates a request to provide a location of the content for delivery to the user of a device. The device operates via the communications system. The content is comprised in a third node. The third node is accessible via the communications system. The content is configured to provide a stimulus of a sense, catalogued as such in the third node, to the user of the device. The first node then initiates, responsive to the obtained first indication, providing the content towards the user of the device via a fourth node.

According to a second aspect of embodiments herein, the object is achieved by a computer-implemented method, performed by the second node. The method is for handling the provision of the content towards the user. The second node operates via the communications system. The second node sends the first indication to the first node operating in the communications system. The first indication indicates the request to provide the location of the content for delivery towards the user of the device operating via the communications system. The content is comprised in the third node accessible via the communications system. The content is configured to provide the stimulus of the sense, catalogued as such in the third node, to the user of the device. The second node also receives, responsive to the sent first indication, directly or indirectly, an eighth indication from the first node. The eighth indication indicates the requested location.

According to a third aspect of embodiments herein, the object is achieved by a computer-implemented method, performed by the third node. The third node is accessible via the communications system. The method is for handling the provision of the content towards the user. The third node receives, directly or indirectly, a fourth indication from the first node operating in the communications system. The fourth indication indicates the request to provide the location of the content for delivery towards the user of the device operating via the communications system. The content is comprised in the third node. The content is configured to provide the stimulus of the sense, catalogued as such in the third node, to the user of the device. The third node then provides, directly or indirectly, in response to the received fourth indication, a fifth indication to the first node. The fifth indication indicates the requested location.

According to a fourth aspect of embodiments herein, the object is achieved by a computer-implemented method, performed by the device. The method is for handling the provision of the content towards the user. The device operates via the communications system. The device receives, directly or indirectly, the eighth indication from the first node operating in the communications system. The eighth indication indicates the location of the content for delivery towards the user of the device. The content is comprised in the third node accessible via the communications system. The content is configured to provide the stimulus of the sense, catalogued as such in the third node, to the user of the device. The device also initiates, responsive to the received eighth indication, providing the content towards the user of the device via the fourth node.

According to a fifth aspect of embodiments herein, the object is achieved by the first node, for handling the provision of the content towards the user. The first node is configured to operate in the communications system. The first node is configured to obtain the first indication from the second node configured to operate via the communications system. The first indication is configured to indicate the request to provide the location of the content for delivery to the user of the device configured to operate in the communications system. The content is configured to be comprised in the third node configured to be accessible via the communications system. The content is configured to provide the stimulus of the sense, configured to be catalogued as such in the third node, to the user of the device. The first node is also configured to initiate, responsive to the obtained first indication, providing the content towards the user of the device via the fourth node.

According to a sixth aspect of embodiments herein, the object is achieved by the second node, for handling the provision of the content towards the user. The second node is configured to operate via the communications system. The second node is configured to send the first indication to the first node configured to operate in the communications system. The first indication is configured to indicate the request to provide the location of the content for delivery towards the user of the device configured to operate in the communications system. The content is configured to be comprised in the third node configured to be accessible via the communications system. The content is configured to provide the stimulus of the sense, configured to be catalogued as such in the third node, to the user of the device. The second node is also configured to receive, responsive to the first indication configured to be sent, directly or indirectly, the eighth indication from the first node. The eighth indication is configured to indicate the location configured to be requested.

According to a seventh aspect of embodiments herein, the object is achieved by the third node, for handling the provision of the content towards the user. The third node is configured to receive, directly or indirectly, the fourth indication from the first node configured to operate in the communications system. The fourth indication is configured to indicate the request to provide the location of the content for delivery towards the user of the device configured to operate in the communications system. The content is configured to be comprised in the third node. The content is configured to provide the stimulus of the sense, catalogued as such in the third node, to the user of the device. The third node is also configured to provide, directly or indirectly, in response to the fourth indication configured to be received, the fifth indication to the first node. The fifth indication is configured to indicate the location configured to be requested.

According to an eighth aspect of embodiments herein, the object is achieved by the device, for handling the provision of the content towards the user. The device is configured to operate via the communications system. The device is configured to receive, directly or indirectly, the eighth indication from the first node configured to operate in the communications system. The eighth indication is configured to indicate the location of the content for delivery towards the user of the device. The content is configured to be comprised in the third node configured to be accessible via the communications system. The content is configured to provide the stimulus of the sense, configured to be catalogued as such in the third node, to the user of the device. The device is also configured to initiate, responsive to the eighth indication configured to be received, providing the content towards the user of the device via the fourth node.

By obtaining the first indication from the second node, the first node may enable the second node to request, via the communications system, the location wherein the content for delivery towards the user of the device may be accessible from, also via the communications system. This may enable the second node to access the third node, which may have a wide content, e.g., sense database.

By the first node initiating providing the content towards the user of the device via the fourth node, the first node may be able to provide towards the device the wide content that be comprised in the third node. The second node may then be enabled to e.g., tune its content according to the sensitivity of the fourth node of the device.

By receiving the eighth indication indicating the obtained requested location from the first node, the second node may receive the answer to the request sent to the first node, including the location, e.g., URL, with the sense. An end user of the second node, e.g., a doctor, may then be enabled to check which sense may have been sent to a patient. The doctor, may, for example, check the test with a sense generator. By doing so, the user of the second node may be enabled to confirm the same test provided to the end user of the device. In other words, the user of the second node may check later with its device which, e.g., smell, may be generated. The user of the second node may only need to access the URL provided in the answer in the same way as end user of the device may do. The second node may then, for example, connect to the location, e.g., the URL, that may contain the requested sense test or may use it using the fourth node, e.g., a sense generator built-in the device, or, e.g., connected via Bluetooth.

By receiving the fourth indication from the first node, the third node may enable the first node to obtain the fifth indication from the third node indicating the location, so the first node may in turn be enabled to initiate providing the eight indication indicating the location of the content towards the device, and in turn enable the delivery of the content towards the user of the device via the fourth node.

By receiving the eighth indication from the first node indicating the location, the device may then be enabled to initiate providing the content towards the user of the device via the fourth node.

Embodiments herein may be understood to enable the device, e.g., a UE, to test its sense generator. Another advantage of embodiments herein may be understood to be that doctors may be able to test sense in end users using telemedicine. Yet another advantage of embodiments herein may be understood to be that a content provider may be able to tune its content according to a sensitivity of the sense generator of the end user.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture, according to existing methods.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a flowchart depicting embodiments of a method in a third node, according to embodiments herein.

FIG. 6 is a flowchart depicting embodiments of a method in a device, according to embodiments herein.

FIG. 7 is a schematic diagram depicting a non-limiting example of signalling between nodes in a communications system, according to embodiments herein.

FIG. 8 is a schematic diagram depicting another non-limiting example of signalling between nodes in a communications system, according to embodiments herein.

FIG. 9 is a schematic block diagram illustrating two non-limiting examples, a) and b), of a first node, according to embodiments herein.

FIG. 10 is a schematic block diagram illustrating two non-limiting examples, a) and b), of a second node, according to embodiments herein.

FIG. 11 is a schematic block diagram illustrating two non-limiting examples, a) and b), of a third node, according to embodiments herein.

FIG. 12 is a schematic block diagram illustrating two non-limiting examples, a) and b), of a device, according to embodiments herein.

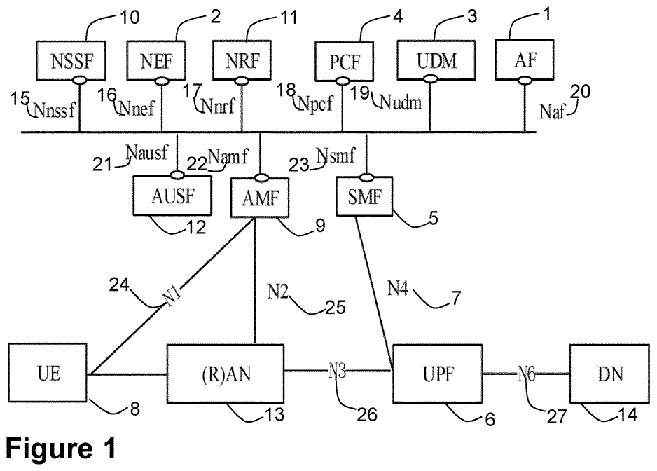

### DETAILED DESCRIPTION

Certain aspects of the present disclosure and their embodiments address one or more of the challenges identified with the existing methods and provide solutions to the challenges discussed.

Embodiments herein may relate to methods of supporting testing of senses in communication systems, such as e.g., 5G networks. According to embodiments herein, a the current 3GPP Exposure framework may be extended by defining a new Application Program Interface (API) between the MNO, e.g., a NEF, and a content provider, e.g., an AF, to exchange information about which sense related media/content may be tested.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

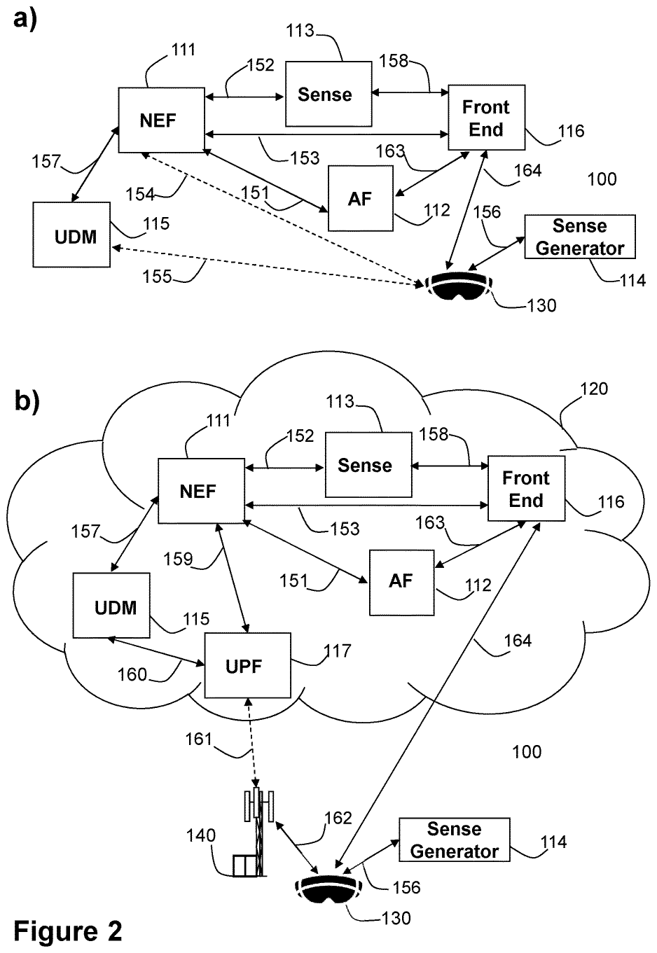

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices. The communications system 100 may for example be a network such as a 5G system, or a newer system supporting similar functionality. The telecommunications system may further support other technologies, such as a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band, Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

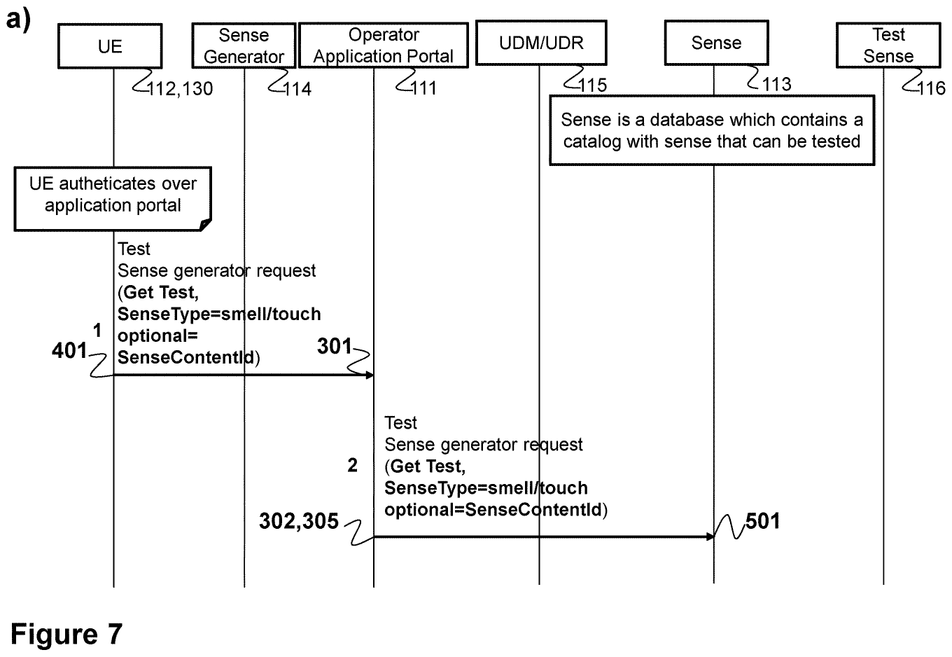

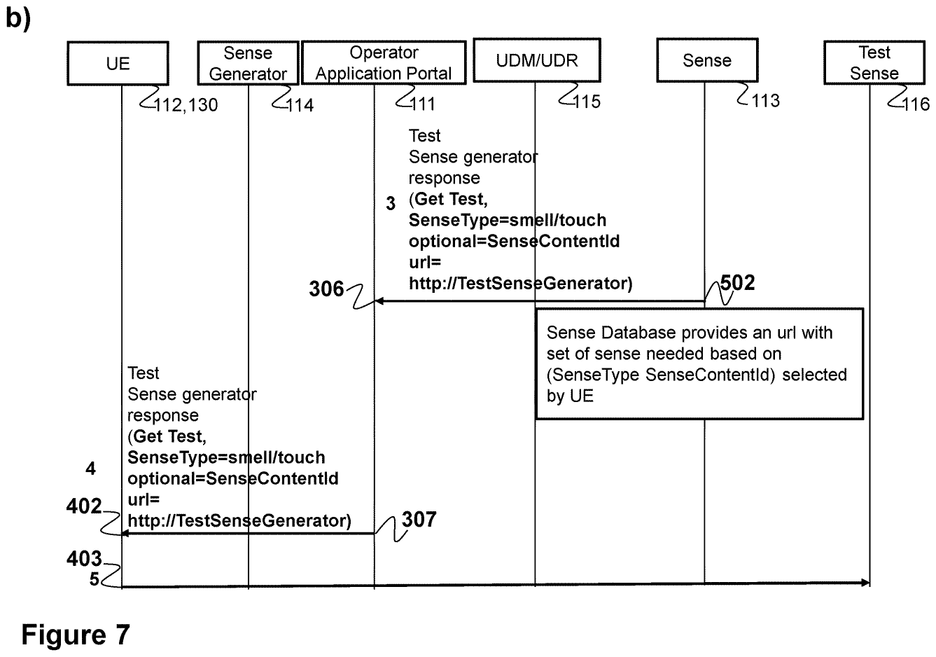

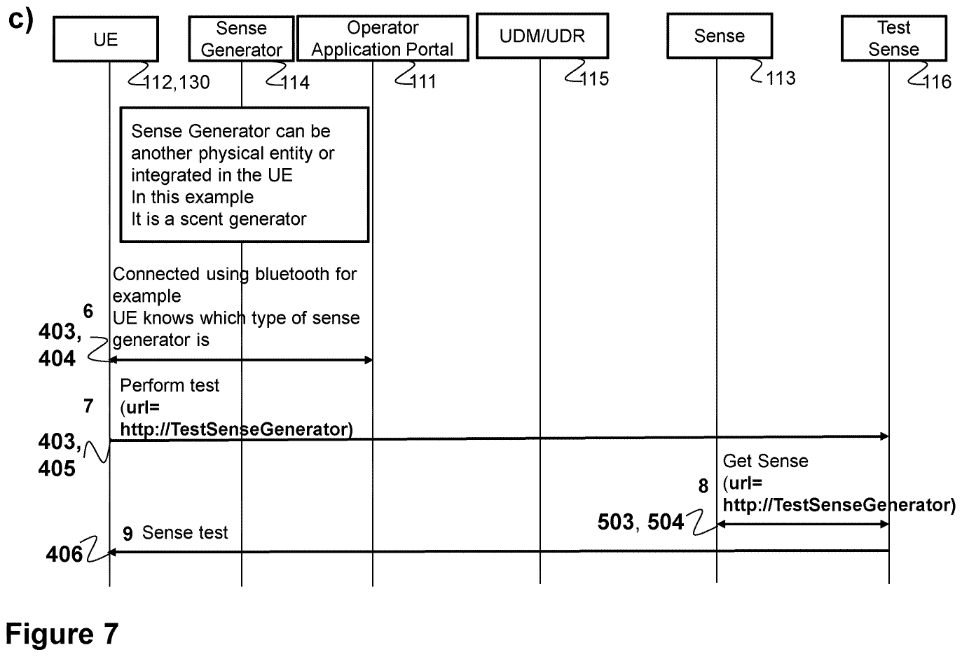

The communications system 100 may comprise a plurality of nodes, and/or operate in communication with other nodes, whereof a first node 111, a second node 112, a third node 113, a fourth node 114, a fifth node 115 and a sixth node 116 are depicted in FIG. 2. The communications system 100 may comprise, in some examples, a seventh node 117, also depicted in FIG. 7. It may be understood that the communications system 100 may comprise more nodes than those represented on FIG. 2. The first node 111, the fifth node 115 and the seventh node 117 are comprised in the communications system 100. The second node 112 and the sixth node 116 operate via the communications system 100, e.g., any of them may be external to the communications system 100. The third node 113 may be accessible via the communications system 100. In some examples, the third node 113 may be comprised in the communications system 100. The fourth node 114 may be any of comprised in the communications system 100 and/or accessible via the communications system 100.

Any of the first node 111, the second node 112, the third node 113, the fourth node 114, the fifth node 115, the sixth node 116 and the seventh node 117 may be understood, respectively, as a first computer system, a second computer system, a third computer system, a fourth computer system, a fifth computer system, a sixth computer system and a seventh computer system. In some examples, any of the first node 111, the second node 112, the third node 113, the fifth node 115, the sixth node 116 and the seventh node 117 may be implemented as a standalone server in e.g., a host computer in the cloud 120, as depicted in the non-limiting example depicted in panel b) of FIG. 2. Any of the first node 111, the second node 112, the third node 113, the fourth node 114, the fifth node 115, the sixth node 116 and the seventh node 117 may in some examples be a distributed node or distributed server, with some of their respective functions being implemented locally, e.g., by a client manager, and some of their functions implemented in the cloud 120, by e.g., a server manager. Yet in other examples, any of the first node 111, the second node 112, the third node 113, the fifth node 115, the sixth node 116 and the seventh node 117 may also be implemented as processing resources in a server farm.

Any of the first node 111, the second node 112, the third node 113, the fifth node 115, the sixth node 116 and the seventh node 117 may be co-localized.

The first node 111 may be a node that may have a capability to manage exposure to different events, e.g., different Exposure APIs. The first node 111 may optionally support other functionalities, such as handling e.g., sponsored Data, Quality of Service (QoS), etc., which may allow a content provider to request policies from the Mobile Network Operator (MNO).

The first node 111 may be understood to act as the entry point into the communications system 100, so the second node 112, e.g., a content provider, may interact with the a core network of the communications system 100 through the first node 111. In some embodiments, as in the non-limiting example of FIG. 2, the first node 111 may be a NEF.

The second node 112 may be a node having a capability to manage service of an application to a device. The second node 112 may interact with the core network of the communications system 100 through the first node 111. The second node 112 may allow external parties to use the APIs offered by the communications system 100. In some particular examples, the second node 112 may be an AF, e.g., in a 5G network. In other examples, the second node 112 may be a device, such as the device 130 described below.

The third node 113 may be a node having a capability to store information, such as sense stimulation. The third node 113 may be understood as a database. In the non-limiting example of FIG. 2, the third node 113 is depicted as a “Sense” database.

The fourth node 114 may be understood as a node having a capability to enable to provide content as a stimulus of a sense, to a user of a device, such as the device 130 described below. The fourth node 114 may be accessible directly by the other nodes comprised in the communications system 100 or may be accessible via the device 130. In some non-limiting particular examples, the fourth node 114 may be a sense generator, as depicted in example of FIG. 2, such as an olfactometer or an electronic nose.

The fifth node 115 may be understood as a node that may have a capability to handle user identification, support a device's Serving NF Registration Management, e.g., storing the serving AMF for a UE, storing the serving SMF for a UE's PDU Session, etc., support retrieval of the device's individual subscription data for access and mobility and session management, and handle subscription for network exposure capabilities applicable to an individual device or a group of devices. As depicted in FIG. 2, a non-limiting example of the fifth node 115, wherein the communications system 100 may be a 5G network, may be a UDM.

The sixth node 116 be understood as a node that may have a capability to interact with an end use or another node or device; it may run or manage an interface function. As depicted in FIG. 2, a non-limiting example of sixth node 116 may be a Front End.

The seventh node 117 be understood as a node that may have a capability to support handling of user plane traffic based on the rules, e.g., received from an SMF, e.g., packet inspection through PDRs and different enforcement actions such as, e.g., event detection and reporting. As depicted in FIG. 2, a non-limiting example of the seventh node 117, wherein the communications system 100 may be a 5G network, may be a UPF.

The communications system 100 may also comprise a device 130 represented in the non-limiting example of FIG. 2 as an Augmented Reality (AR) headset. The device 130 may be also known as e.g., user equipment (UE), a wireless device, mobile terminal, wireless terminal and/or mobile station, mobile telephone, cellular telephone, or laptop with wireless capability, an Internet of Things (IoT) device, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, e.g., between the device 130 and the fourth node 114, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 2b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the third node 113 over a second link 152, e.g., a radio link or a wired link. The first node 111 may communicate with the sixth node 116 over a third link 153, e.g., a radio link or a wired link. The first node 111 may communicate with the device 130, e.g., indirectly, over a fourth link 154, e.g., a radio link or a wired link. The fifth node 115 may communicate with the device 130, e.g., indirectly, over a fifth link 155, e.g., a radio link or a wired link. The device 130 may communicate with the fourth node 114 over a sixth link 156, e.g., a radio link or a wired link.

The first node 111 may communicate with the fifth node 115 over a seventh link 157, e.g., a radio link or a wired link. The third node 113 may communicate with the sixth node 116 over an eighth link 158, e.g., a radio link or a wired link. The first node 111 may communicate with the seventh node 117 over a ninth link 159, e.g., a radio link or a wired link. The fifth link 115 may communicate with the seventh node 117 over a tenth link 160, e.g., a radio link or a wired link. The radio network node 140 may communicate, directly or indirectly with one or more nodes comprised in the communications system 100 such as the seventh node 117, via an eleventh link 161, e.g., a radio link or a wired link. The radio network node 140 may communicate with the device 130 over a twelfth link 162, e.g., a radio link. The second node 112 may communicate with the sixth node 116 over a thirteenth link 163, e.g., a radio link. The sixth node 116 may communicate with the device 130 over a fourteenth link 164, e.g., a radio link.

Any of the first link 151, the second link 152, the third link 153, the fourth link 154, the fifth link 155, the sixth link 156, the seventh link 157, the eighth link 158, the ninth link 159, the tenth link 160, the eleventh link 161, the twelfth link 162, the thirteenth link 163 and/or the fourteenth link 164 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

In general, the usage of “first”, “second”, “third”, “fourth”, “fifth”, “sixth”, “seventh”, “eighth”, “ninth”, “tenth”, “eleventh”, “twelfth”, “thirteenth” and/or “fourteenth” herein may be understood to be an arbitrary way to denote different elements or entities and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

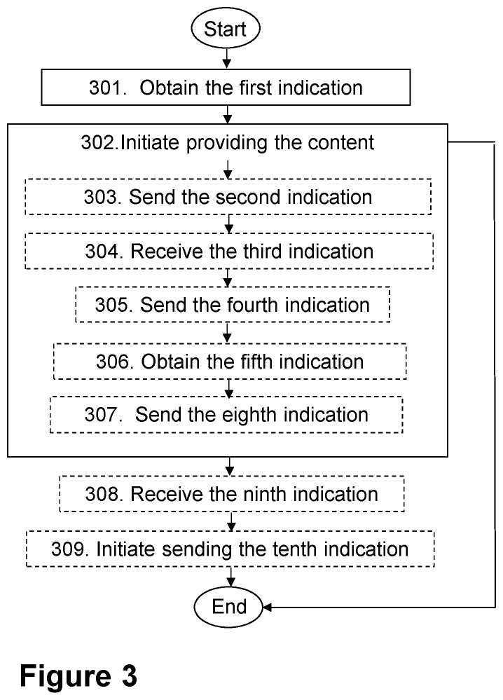

Embodiments of a computer-implemented method, performed by the first node 111, will now be described with reference to the flowchart depicted in FIG. 3. The method may be understood to be for handling provision of content towards a user. The first node 111 operates in the communications system 100.

In some embodiments, the communications system 100 may be a Fifth Generation, 5G, system.

Several embodiments are comprised herein. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 3.

In FIG. 3, optional actions are represented with dashed lines.

### Action 301

In this Action 301, the first node 111 obtains a first indication from the second node 112. The second node 112 operates via the communications system 100. In some embodiments, the first node 111 may be an Application Server (AS), e.g., an application portal of an operator, and the second node 112 may be the device 130. In some embodiments, the first node 111 may be a NEF and the second node 112 may be an AF.

Obtaining may comprise any of retrieving, fetching or receiving. The obtaining, e.g., receiving, may be performed e.g., via the first link 151.

The first indication indicates a request to provide a location of the content for delivery to the user of the device 130.

The device 130 operates via the communications system 100. The content is comprised in the third node 113. The third node 113 is accessible via the communications system 100. The third node 113 may be a sense database.

The content is configured to provide a stimulus of a sense, catalogued as such in the third node 113, to the user of the device 130. Content may be understood herein as digital information that, when reproduced on the fourth node 114, e.g., a sense generator, instructs the fourth node 114 to provide the stimulus of the sense, as analog information, to the user of the device 130.

In some embodiments, the sense may be one of olfaction and touch.

The request to provide the location of the content for delivery may be to perform a test on the content. For example, the second node 112, e.g., a content provider, may ask to check different smells, to test which primary smells an end user of the device 130 may be able to recognize before sending any subsequent content, just to check if the fourth node 114 may be able to reproduce the selected content sense accordingly. In another example, the second node 112 may be the AF of a doctor, who may request the MNO, e.g., with the first node 111 as NEF, to perform a sense test. In some of such examples, the first indication may be for example, a “Nnef Sense Detector Subscribe Request”.

The test may be a calibration of the content. For example, the second node 112, e.g., a content provider or AF of a doctor, may ask to check which primary smells an end user of the device 130 may be able to recognize. If the end user cannot recognize the smell/s or misunderstands those that may be instructed to be provided by the second node 112, those may not be sent subsequently. By obtaining the first indication from the second node 112 in this Action 301, the first node 111 may enable an end user of the device 130, via the first node 111, e.g., the operator portal, to define if he/she may want to check the correct behavior of the fourth node 114, e.g., the sense generator. In some of such embodiments, the first indication may be e.g., a “Test Sense generator request”.

The location may be a Uniform Resource Locator (URL).

In some embodiments, the first indication may comprise at least one of: a) a first identifier of type of sense, and b) a second identifier of the content. In some examples, the first indication may specify that the sense is smell or e.g., touch. The first identifier of the type of sense may be, e.g., “SenseType=smell/touch”. In some examples, the first indication may specify the specific content that may want to be tested, e.g., the smell of rose. The second node 112 may request a test for all sense content, or a list of specific sense content. The second identifier may be, e.g., a “SenseContentId”, for example, “SenseContentId=Rose”. In some examples, the second node 112 may provide which kind of sense the second node 112 may want to test, e.g., smell/touch, and which content, e.g., rose, etc. For smell, there may be ten primary smells: floral, woody, fruity, ethereal, pepperminty, sweet, smoky or burning, citric, putrid and acre or musty. If no content is selected, e.g., if SenseContentld is empty, the fourth node 114 may be checked towards whole catalogue of values for each specific sense. In yet other examples, the first indication may comprise a third identifier of the device 130, e.g., a UE-ID.

In a particular example, the first indication may be a Test Sense generator request (Get Test, SenseType=smell/touch with optionally SenseContentld).

In another particular example, the first indication may be a “Nnef Sense Detector Subscribe Request (Sense=Smell, SenseContentid=Rose UE-ID)”.

By obtaining the first indication in this Action 301, the first node 111 may enable the second node 112 to request, via the communications system 100 the location wherein the content for delivery towards the user of the device 130 may be accessible from, also via the communications system 100. This may enable the second node 112 to gain access to the content comprised in the third node 113, which may be a wide sense database, as e.g., the second node 112 on its own, which may not have access to such content. The second node 112 may then be enabled to e.g., tune its content according to the sensitivity of the fourth node 114 of the device 130.

### Action 302

In this Action 302, the first node 111 initiates, responsive to the obtained first indication, providing the content towards the user of the device 130 via the fourth node 114. Initiating may be understood as triggering, starting, facilitating or enabling. The fourth node 114 may be controlled by the device 130.

In some embodiments, wherein the third node 113 may be the sense database, the fourth node 114 may be a sense generator, and one of the following options may apply. According to a first option, the first node 111 may be the AS, and the second node 112 may be the device 130. According to a second option, the first node 111 may be the NEF and the second node 112 may be the AF.

The request to provide the location of the content for delivery may be to perform the test on the content. The test may be the calibration of one of the fourth node 114 and the content. The initiating providing in this Action 302 may comprise one or more of the following Actions 303-307.

By the first node 111 initiating providing the content towards the user of the device 130 via the fourth node 114 in this Action 302, the first node 111 may be able to provide towards the device 130 the wide content that be comprised in the third node 113. The second node 112 may then in turn be enabled to e.g., tune its content according to the sensitivity of the fourth node 114 of the device 130.

### Action 303

In some embodiments, the initiating providing in Action 302 may further comprise that the first node 111, in this Action 303, may send, based on the obtained first indication, a second indication to the fifth node 115 operating in the communications system 100. The second indication may request whether or not the second node 112 may have consent to submit the request.

The second indication may be, for example, a “Nudm Consent Request”. The second indication may, in some examples, comprise the third identifier of the device 130, e.g., UE-ID. The sending in this Action 303 may be performed, e.g., via the seventh link 157. By sending the second indication in this Action 303, the first node 111 may be able to validate towards the fifth node 115, e.g., the UDR, if the device 130 may have provided consent for the type of request obtained by the first node 111 in Action 301.

### Action 304

In some embodiments, the initiating providing in Action 302 may further comprise that the first node 111, in this Action 304, may receive a third indication from the fifth node 115. The receiving of the third indication in this Action 304 may be in response to the sent second indication. The third indication may indicate whether or not the second node 112 may have consent to submit the request.

The receiving of the in this Action 304 may be performed e.g., via the seventh link 157. By receiving the third indication in this Action 304, the first node 111 may be enabled to know whether or not the fifth node 115 may have validated the previous request. The third indication may be for example, “Nudm Consent Response (200 OK)”.

### Action 305

In some embodiments, the initiating providing in Action 302 may further comprise that the first node 111, in this Action 305, may send, directly or indirectly, based on the received first indication, a fourth indication to the third node 113. The fourth indication may indicate the request to provide the location of the content for delivery.

The first node 111 may be understood to forward the first indication to the third node 113 as the fourth indication. Hence, all the features described in Action 301 for the first indication may be understood to similarly apply to the fourth indication. In a particular example, the fourth indication may be the Test Sense generator request (Get Test, SenseType=smell/touch with optionally SenseContentld).

The fourth indication may be sent via the sixth node 116, wherein the sixth node 116 may be a front end test server. By sending the fourth indication via the sixth node 116, the first node 111 may ask the front end for the specific test requested by the second node 112. Using the sixth node 116 may be understood to enable to provide an interface to end users and machines. There may be understood to be advantages by splitting functions, since it may be possible to e.g., scale the front end functionality while the backend may remain without scaling.

The sending in this Action 305 may be performed e.g., via the second link 152.

By sending the fourth indication to the sixth node 116 in this Action 305, the first node 111 may enable the sixth node 116 to ask the third node 113 for the location, e.g., the URL, where the content requested in Action 301 may be tested.

### Action 306

In some embodiments, the initiating providing in Action 302 may further comprise, that the first node 111, in this Action 306, may obtain, directly or indirectly, in response to the sent fourth indication, a fifth indication from the third node 113. The fifth indication may indicate the requested location.

Obtaining may comprise any of retrieving, fetching or receiving. The obtaining, e.g., receiving, may be performed e.g., via the second link 152.

The fifth indication may indicate a response to the request to provide the location of the content for delivery towards the user of the device 130.

In some examples, the fifth indication may be e.g., a “Test Sense generator response”. In some embodiments, e.g., where Action 306 may have been performed, the fifth indication may be received via the sixth node 116. In some of such embodiments, the fifth indication may be, e.g., a Test Sense generator Subscribe Response.

The location may be the URL, e.g., “url=http://TestSenseGenerator”. The location may be understood as an ULR where the content requested in Action 301 may be tested. The third node 113 may provide the URL with the set of sense requested, based on the first identifier, e.g., SenseType and/or second Identifier, e.g., SenseContentld, selected by the second node 112, e.g., the device 130.

In some examples, the fifth indication may comprise at least one of: a) the first identifier of type of sense, and b) the second identifier of the content.

In a particular non-limiting example, the first indication may be a Test Sense generator response (Get Test, SenseType=smell/touch with optionally SenseContentld, url=http://TestSenseGenerator).

In some embodiments wherein the fifth indication may have been received via the sixth node 116, the fifth indication may be, e.g., a Test Sense generator Subscribe Response (SenseType=smell SenseContentId=Rose url=http://TestSense:smell.RoseUEID))

By obtaining fifth indication from the third node 113 in this Action 306, the first node 111 may be enabled to obtain the corresponding location, e.g., URL, to identify the content, e.g., the sense, to be provided towards the device 130 and towards the second node 112.

### Action 307

In some embodiments, the initiating providing in Action 302 may further comprise, that the first node 111, in this Action 307, may send, directly or indirectly, an eighth indication towards the device 130. The eighth indication may indicate the obtained requested location.

In some examples, the eighth indication may be e.g., a “SendSense” message. In another example, the eight indication may be a “SenseDetector Response”.

The sending of the eighth indication in this Action 307 may be performed e.g., via the fourth link 154.

In some embodiments, in this Action 307, the first node 111 may be understood to forward the fifth indication towards the device 130, e.g., via the seventh node 117, as the eighth indication. Hence, all the features described in Action 307 for the fifth indication may be understood to similarly apply to the eighth indication.

The location may be the URL.

In some examples, the eighth indication may comprise at least one of: a) the first identifier of type of sense, and b) the second identifier of the content.

The eighth indication may further comprise the third identifier of the device 130. In a particular example, the eighth indication may be a Nupf SendSense (SenseType=smell SenseContentId=Rose.url=http://TestSense: smell.RoseUEID UE-ID).

In another example, the eight indication may be a Nnef SenseDetector Response (200 OK, url=http://TestSense: smell.RoseUEID).

By sending the eighth indication indicating the obtained requested location towards the device 130, the first node 111 may enable the device 130 to then connect to the location, e.g., the URL, that may contain the requested sense test or may use it using the fourth node 114, e.g., a sense generator built-in the device 130, or, e.g., connected via Bluetooth.

By sending the eighth indication indicating the obtained requested location towards, e.g., to, the second node 112, the first node 111 may send an answer to the request obtained in Action 301 from the second node 112, including the location, e.g., URL with the sense that may be going to be tested. A user of the second node 112, e.g., a doctor, may then be enabled to check which sense that may have been sent to its patient. The doctor, may, for example, check the test with a sense generator similar to the fourth node 114. By doing so, the user of the second node 112 may be enabled to confirm the same test provided to the end user of the device 130.

### Action 308

In some embodiments wherein the request to provide the location of the content for delivery may be to perform the test on the content, the first node 111 may, in this Action 308, receive, based on the obtained first indication, a ninth indication from the sixth node 116. The ninth indication may indicate a result of the test.

The receiving in this Action 308 may be performed e.g., via the third link 153.

The ninth indication may be understood as a notification of the results of the test.

The ninth indication may be, for example, a Test SenseGenerator Notify.

In some examples, the ninth indication may comprise at least one of: a) the first identifier of type of sense, and b) the second identifier of the content. The ninth indication may further comprise the third identifier of the device 130.

In a particular example, the ninth indication may be a Test SenseGenerator Notify (SenseType=smell SenseContentId=Rose UE-ID Results).

By receiving the ninth indication from the sixth node 116 in this Action 308, the first node 111 may then be enabled to indicate the result of the test to the second node 112. The second node 112 may then be enabled to e.g., tune its content according to the sensitivity of the fourth node 114 of the device 130.

### Action 309

In some embodiments wherein the request to provide the location of the content for delivery may be to perform the test on the content, the first node 111 may, in this Action 309, initiate sending, responsive to the received ninth indication, a tenth indication to the second node 112. The tenth indication may indicate the result of the test.

The sending in this Action 309 may be performed e.g., via the firs link 151.

The tenth indication may be understood as a notification to the second node 112, e.g., a doctor's device, of the results of the test.

The first node 111 may be understood to forward the ninth indication to the second node 112 as the tenth indication. Hence, all the features described in Action 308 for the ninth indication may be understood to similarly apply to the tenth indication. That is, in some examples, the tenth indication may comprise at least one of: a) the first identifier of type of sense, and b) the second identifier of the content. The tenth indication may further comprise the third identifier of the device 130.

In a particular example, the fourth indication may be the Test Sense generator Notify (SenseType=smell SenseContentId=Rose UE-ID Results).

By sending the tenth indication to the second node 112 in this Action 309, the first node 111 may then enable the second node 112 to e.g., tune its content according to the sensitivity of the fourth node 114 of the device 130.

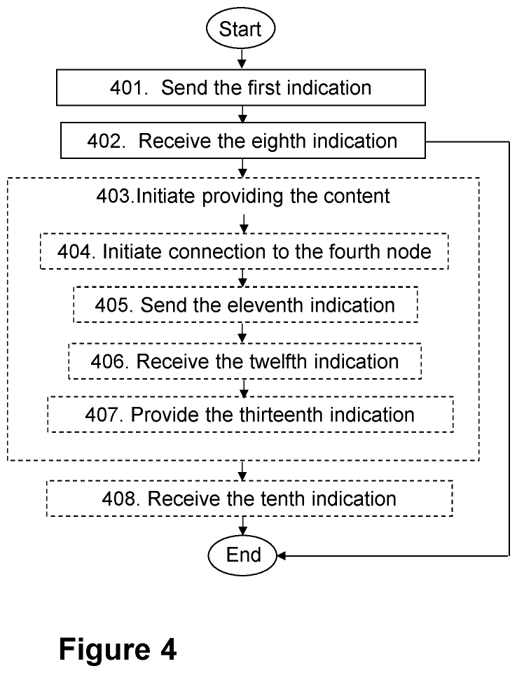

Embodiments of a computer-implemented method performed by the second node 112, will now be described with reference to the flowchart depicted in FIG. 4. The method may be understood to be for handling the provision of the content towards the user. The second node 112 operates via the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, in some embodiments, the first indication may comprise a third identifier of the device 130, e.g., a UE-ID.

### Action 401

In this Action 401, the second node 112 sends the first indication to the first node 111 operating in the communications system 100. The first indication indicates the request to provide the location of the content for delivery towards the user of the device 130 operating via the communications system 100. The content is comprised in the third node 113 accessible via the communications system 100. The content is configured to provide the stimulus of the sense, catalogued as such in the third node 113, to the user of the device 130.

The sending in this Action 401 may be performed e.g., via the first link 151.

In some embodiments, at least one of the following options may apply: a) the fourth node 114 may be controlled by the device 130, b) the sense may be one of olfaction and touch, c) the request to provide the location of the content for delivery may be to perform the test on the content, d) the test may be the calibration of the one of the fourth node 114 and the content, and e) the location may be the URL.

In some embodiments, the first indication may comprise at least one of: a) the first identifier of type of sense, and b) the second identifier of the content.

In some embodiments, wherein the third node 113 may be the sense database, the fourth node 114 may be the sense generator, and one of the following options may apply. According to the first option, the first node 111 may be the AS, and the second node 112 may be the device 130. According to the second option, the first node 111 may be the NEF and the second node 112 may be the AF, e.g., the AF of a doctor.

### Action 402

In this Action 402, the second node 112 receives, responsive to the sent first indication, directly or indirectly, the eighth indication from the first node 111. The eighth indication indicates the requested location.

By receiving the eighth indication indicating the obtained requested location from the first node 111 in this Action 402, the second node 112 may receive the answer to the request sent in Action 401 to the first node 111, including the location, e.g., URL, with the sense that may be going to be tested. In some embodiments, the second node 112 may be the device 130 itself. In other examples, the user of the second node 112, e.g., a doctor, may then be enabled to check which sense may have been sent to its patient. The doctor, may, for example, check the test with a sense generator similar to the fourth node 114. By doing so, the user of the second node 112 may be enabled to confirm the same test provided to the end user of the device 130. In other words, the user of the second node 112 may check later with its device which smell may be generated. The user of the second node 112 may only need to access the URL provided in the answer in the same way as end user of the device 130 may do. The second node 112 may then, for example, connect to the location, e.g., the URL, that may contain the requested sense test or may use it using the fourth node 114, e.g., a sense generator built-in the device 130, or, e.g., connected via Bluetooth.

### Action 403

In this Action 403, the second node 112 may initiate, responsive to the received eighth indication, providing the content towards the user of the device 130 via the fourth node 114.

The initiating providing in this Action 403 may comprise one or more of the following Actions 404-407.

### Action 404

In some embodiments the initiating providing in Action 403 may further comprise, in this Action 404, that the second node 112 may initiate connection to the fourth node 114. For example, the second node 112 may start up, or establish the connection, e.g., a Bluetooth connection, to the fourth node 114.

### Action 405

In some embodiments, the initiating providing in Action 403 may further comprise, in this

Action 405, that the second node 112 may send an eleventh indication to the sixth node 116 operating via the communications system 100. The eleventh indication may indicate the requested location.

The sending in this Action 405 may be performed, e.g., via the thirteenth link 163. The eleventh indication may be, for example, Perform test (url=http://TestSenseGenerator).

By sending the eleventh indication in this Action 405, the second node 112 may request a test of the sense content. The second node 112 may then be enabled to e.g., tune its content according to the sensitivity of the fourth node 114 of the device 130.

### Action 406

In some embodiments the initiating providing in Action 403 may further comprise, in this Action 407, that the second node 112 may receive a twelfth indication from the sixth node 116. The twelfth indication may comprise the content. The twelfth indication may comprise, for example, the test of the sense content.

The receiving in this Action 406 may be performed, e.g., via the thirteenth link 163. By receiving the twelfth indication in this Action 406, the second node 112 may then be enabled to e.g., tune its content according to the sensitivity of the fourth node 114 of the device 130.

### Action 407

In some embodiments the initiating providing in Action 403 may optionally further comprise, in this Action 407, that the second node 112 may provide a thirteenth indication indicating a sensation caused by delivery of the content towards the user of the device 130.

Providing in this Action 407 may be understood as e.g., outputting in an interface, e.g., a screen of the second node 112, or sending to another node or device.

### Action 408

In some embodiments wherein the request to provide the location of the content for delivery may be to perform the test on the content, in this Action 408, the second node 112 may receive, responsive to the sent first indication, the tenth indication from the first node 111. The tenth indication may indicate the result of the test.

The receiving in this Action 408 may be performed, e.g., via the first link 151.

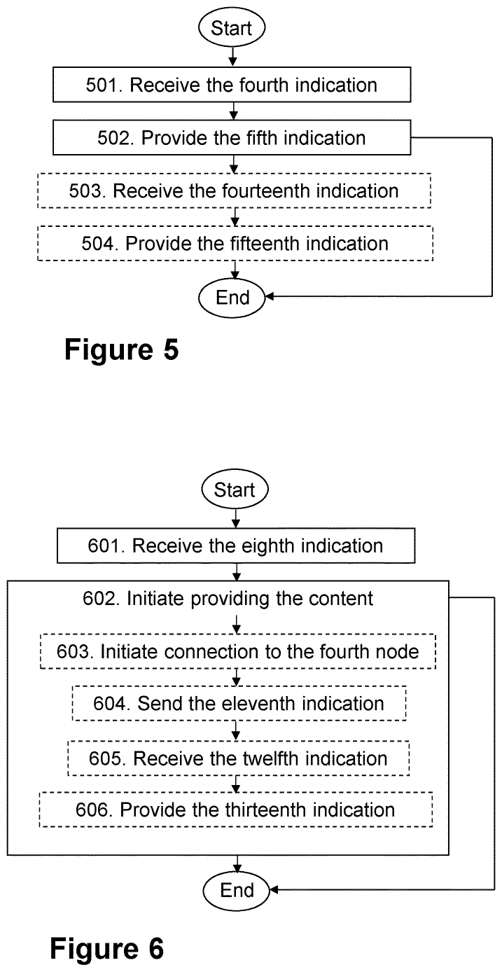

Embodiments of a computer-implemented method performed by the third node 113, will now be described with reference to the flowchart depicted in FIG. 5. The third node 113 is accessible via the communications system 100. The method may be understood to be for handling the provision of the content towards the user.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are depicted with dashed lines.

The detailed description of some of the following corresponds to the same references provided above, in relation to the actions described for the first node 111 and will thus not be repeated here to simplify the description. For example, in some embodiments, the second identifier may be, e.g., a “SenseContentId”, for example, “SenseContentId=Rose”.

### Action 501

In this Action 501, the third node 113 receives, directly or indirectly, the fourth indication from the first node 111 operating in the communications system 100. The fourth indication indicates the request to provide the location of content for delivery towards the user of the device 130 operating via the communications system 100. The content is comprised in the third node 113. The content is configured to provide the stimulus of the sense, catalogued as such in the third node 113, to the user of the device 130.

The receiving of the fourth indication may be performed e.g., via the second link 152. In some embodiments, the fourth indication may comprise at least one of: a) the first identifier of type of sense, and b) the second identifier of the content.

In some embodiments, the fourth indication may be received via the sixth node 116, wherein the sixth node 116 may be the front end test server.

In some embodiments, at least one of the following options may apply: a) the content may be configured to provide the stimulus of the sense to the user of the device 130 via the fourth node 114, b) the fourth node 114 may be controlled by the device 130, b) the sense may be one of olfaction and touch, c) the request to provide the location of the content for delivery may be to perform the test on the content, d) the test may be the calibration of the one of the fourth node 114 and the content, and e) the location may be the URL.

In some embodiments, wherein the third node 113 may be the sense database, the fourth node 114 may be a sense generator, and one of the following options may apply. According to a first option, the first node 111 may be the AS. According to a second option, the first node 111 may be the NEF.

### Action 502

The third node 113, in this Action 502, provides, directly or indirectly, in response to the received fourth indication, the fifth indication to the first node 111. The fifth indication indicates the requested location.

In some embodiments, e.g., where Action 306 may have been performed, the fifth indication may be provided via the sixth node 116.

### Action 503

The third node 113 may, in this Action 503, receive, based on the sent fifth indication, a fourteenth indication from the sixth node 116, the fourteenth indication requesting the content. For example, the sixth node 116 may be a Test URL provider, which in this Action 503 may request from the third node 113 the corresponding sense. In another example, the sixth node 116 may be a Front End which, in this Action 503, may request sense information according to the URL from the third node 113.

In some embodiments, the fourteenth indication may comprise at least one of: a) the first identifier of type of sense, and b) the second identifier of the content.

The fourteenth indication may, in some examples, comprise the third identifier of the device 130, e.g., UE-ID.

The fourteenth indication may be, for example, “Get Sense (url=http://TestSenseGenerator)”, o “Get Sense (url=http://TestSense: smell.RoseUEID)”.

The receiving of the fourteenth indication may be performed e.g., via the eighth link 158. By receiving the fourteenth indication from the sixth node 116 in this Action 503, the third node 113 may enable the sixth node 116 to request the content from the third node 113, for later delivery towards the device 130.

### Action 504

The third node 113 may, in this Action 504, provide, responsive to the received fourteenth indication, a fifteenth indication indicating the content, to the sixth node 116. For example, in this Action 504, the third node 113, e.g., a Sense database, may send the corresponding sense to the sixth node 116, e.g., a Test URL provider. In another example, the sixth node 116 may be a Front End, which in this Action 504 may get sense information according to the URL from third node 113.

The fifteenth indication may be, for example, a “Get Sense (url=http://TestSenseGenerator)”, o “Get Sense (url=http://TestSense: smell.RoseUEID)”.

The providing of the fifteenth indication may be performed e.g., via the eighth link 158. By providing the fifteenth indication indicating the content to the sixth node 116 in this Action 504, the third node 113 may enable the sixth node 116 to then send the sense information towards the device 130, which may be the same as the second node 112 in some embodiments. This may in turn enable the sixth node 116 to also ask about what end user of the device 130 may be able to smell in the test. The end user may then provide feedback about the result of the test. The end user may provide the smell of the test towards the sixth node 116. Optionally, the sixth node 116 may in turn be enabled to store the results of the test so they may be later checked by e.g., an end user of the second node 112, who may then be able to later request the results of this user from the sixth node 116, and the sixth node 116 may ultimately notify the second node 112 about the results of the test.

Embodiments of a computer-implemented method performed by the device 130, will now be described with reference to the flowchart depicted in FIG. 6. The method may be understood to be for handling the provision of the content towards the user. The device 130 operates via the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first node 111 and will thus not be repeated here to simplify the description. For example, in some embodiments, the second identifier may be, e.g., a “SenseContentId”, for example, “SenseContentId=Rose”.

### Action 601

In this Action 601, the device 130 receives, directly or indirectly, the eighth indication from the first node 111 operating in the communications system 100. The eighth indication indicates the location of content for delivery towards the user of the device 130. The content is comprised in the third node 113 accessible via the communications system 100. The content is configured to provide the stimulus of the sense, catalogued as such in the third node 113, to the user of the device 130.

The third node 113 may be the sense database. The fourth node 114 may be the sense generator.

In some embodiments, at least one of the following options may apply: a) the fourth node 114 may be controlled by the device 130, b) the sense may be one of olfaction and touch, c) the location of the content for delivery may be to perform the test on the content, d) the test may be the calibration of the one of the fourth node 114 and the content, and e) the location may be the URL.

In some examples, the eighth indication may comprise at least one of: a) the first identifier of type of sense, and b) the second identifier of the content.

The receiving, in this Action 601 may be performed, e.g., via the fourth link 154.

### Action 602

The device 130, in this Action 602, initiates 602, responsive to the received eighth indication, providing the content towards the user of the device 130 via the fourth node 114.

The initiating providing in this Action 602 may comprise one or more of the following Actions 603-606.

### Action 603

In some embodiments, the initiating providing in Action 602 may further comprise that the device 130, in this Action 603, may initiate connection to the fourth node 114. This may be performed by starting the fourth node 114, or by establish a connection, e.g., a radio connection such as Bluetooth connection, to the fourth node 114, e.g., via the sixth link 156.

### Action 604

In some embodiments, the initiating providing in Action 602 may further comprise that the device 130, in this Action 604, may send the eleventh indication to the sixth node 116 operating via the communications system 100. The eleventh indication indicates the received location.

### Action 605

In some embodiments, the initiating providing in Action 602 may further comprise that the device 130, in this Action 605, may receive the twelfth indication from the sixth node 116. The twelfth indication may comprise the content.

The receiving in this Action 605 may be performed, e.g., via the fourteenth link 164.

### Action 606

In some embodiments, the initiating providing in Action 602 may further comprise that the device 130, in this Action 606, may provide the thirteenth indication indicating the sensation caused by delivery of the content towards the user of the device 130.

Providing in this Action 606 may be understood as e.g., outputting in an interface, e.g., a screen of the device 130, or sending to another node or device.

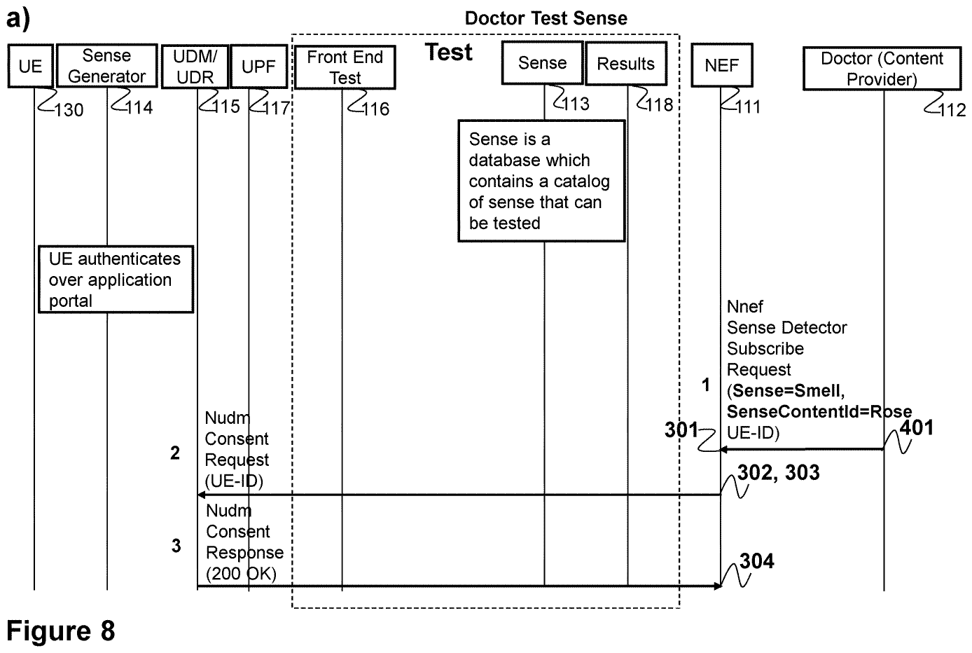

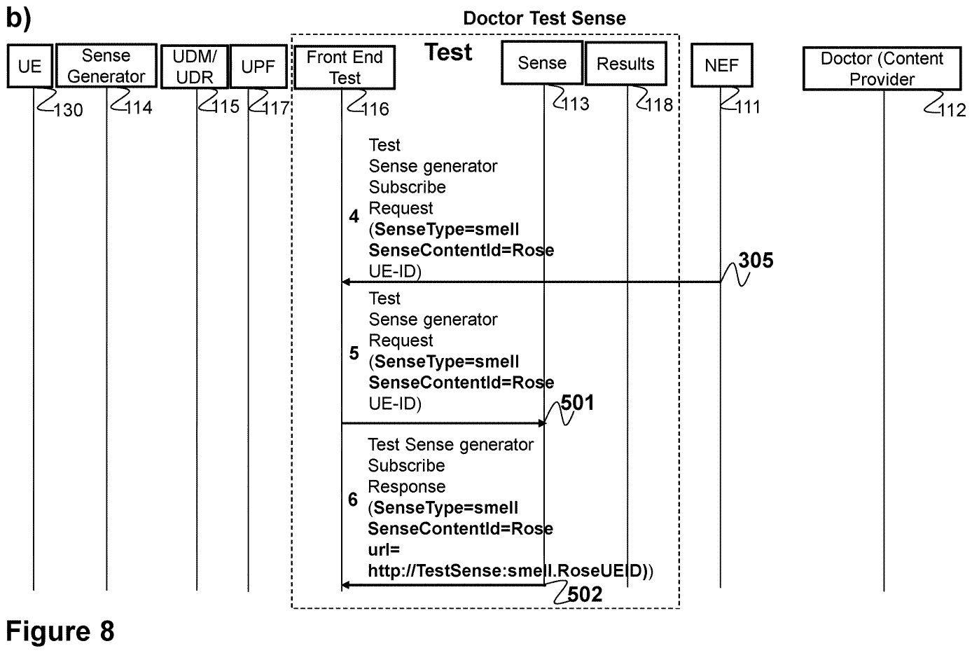

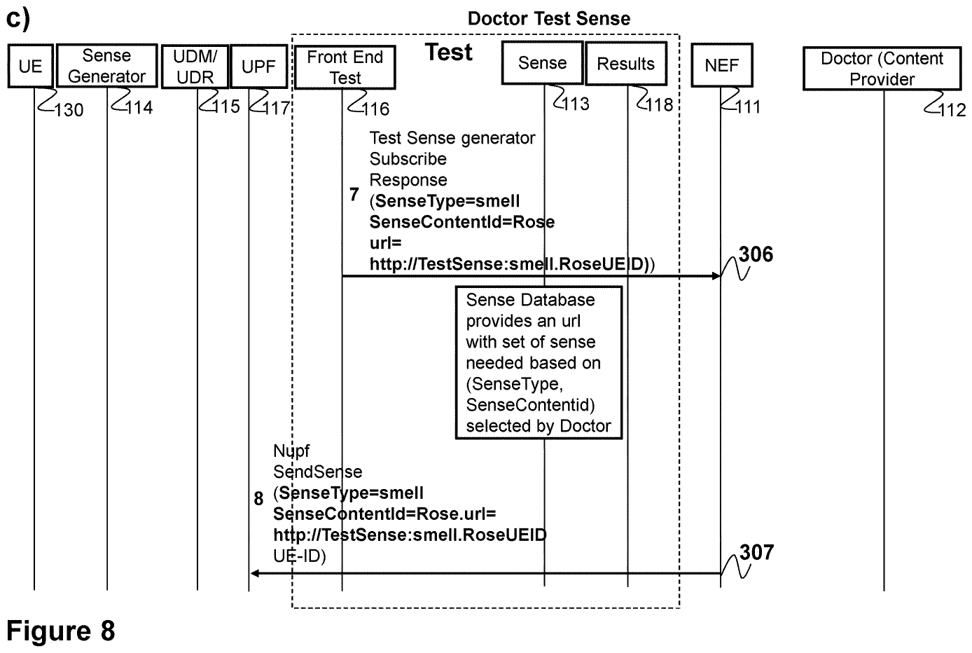

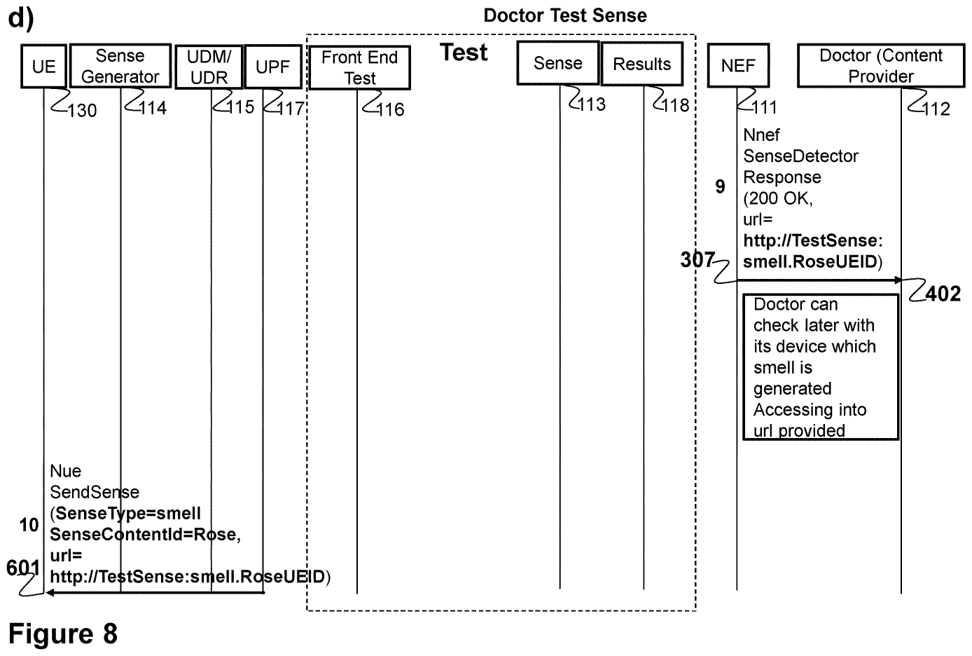

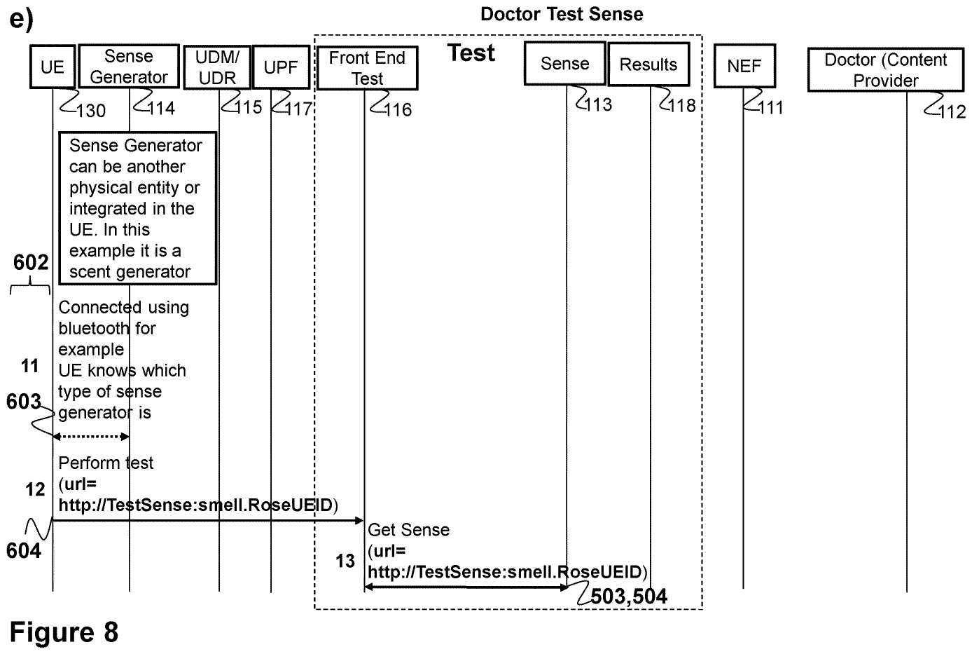

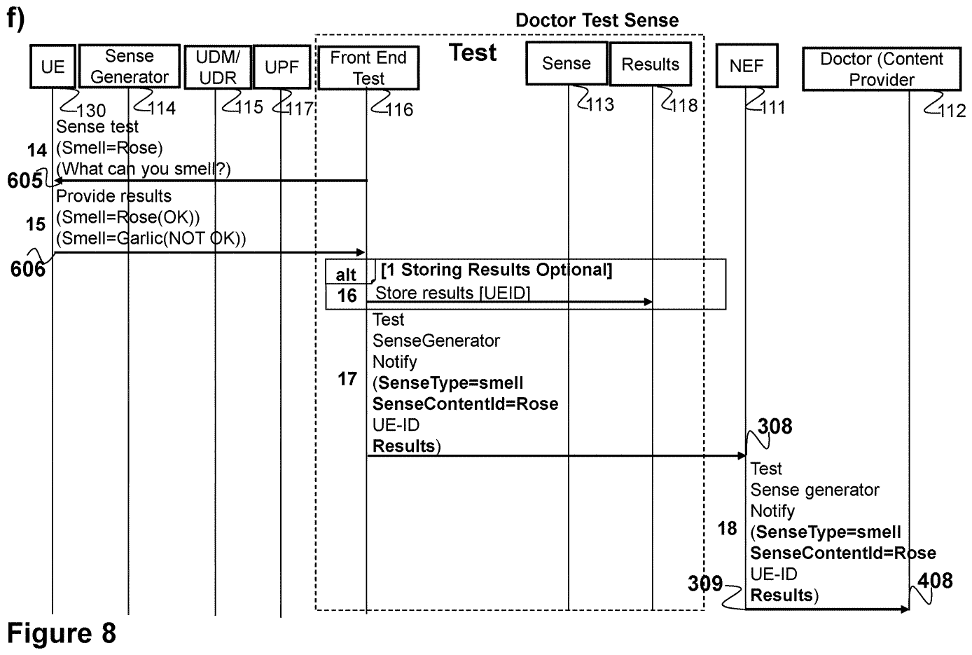

Several non-limiting examples of a method in the communications system 100 according to embodiments herein will now be described in the next FIGS. 7 and 8. In FIGS. 7-8, the communications system 100 is a 5G network, the first node 111 is a an Application Portal of an Operator in FIG. 7 and a NEF in FIG. 8, the second node 112 is the device 130 in FIG. 7 or a Content Provider, the AF of a Doctor, in FIG. 8, the third node 113 is an Sense Database, the fourth node 114 is a Sense Generator, the fifth node 115 is a UDM, the sixth node 116 is a Front End, the seventh node 117 is a UPF and the device 130 is a UE. It may be understood that in the following examples depicted in FIG. 7-8, any reference to the NEF may be understood to equally refer to the first node 111, any reference to the device 130 in FIG. 7 or the AF in FIG. 8 may be understood to equally refer to the second node 112, any reference to the Sense Database may be may be understood to equally refer to the third node 113, any reference to the Sense Generator may be may be understood to equally refer to the fourth node 114, any reference to the UDM/UDR may be may be understood to equally refer to the fifth node 115, any reference to the Front End Test, or Front End Test server, may be may be understood to equally refer to the sixth node 116, and any reference to the UPF may be may be understood to equally refer to the seventh node 117.

FIG. 7 is a signalling diagram depicting a first non-limiting example of a method performed in the communications system 100, according to embodiments herein, over panels a), b) and c). The example of FIG. 7 depicts an example of a first group of embodiments, wherein an individual test sense may be conducted. Particularly, a process is depicted for calibrating and checking that the fourth node 114, a sense generator, works as expected. In this example, the third node 113 is a sense database that contains a catalog with different senses that may be tested. Also in this example, the second node 112 is the same as the device 130. Starting on panel a) the second node 112 may initially authenticate over the first node 111, which in this example, is the application portal of an operator. In Step 1, an end user of the device 130, via the operator portal, may, according to Action 401 and Action 301, define if he/she may want to check that this sense generator may behave correctly by sending the first indication providing which kind of sense the user may want to test, e.g., smell/touch, and the content, e.g., rose, etc. In this example, the first indication is a Test Sense generator request (Get Test, SenseType=smell/touch optional=SenseContentld). If no content is selected, that is, if SenseContentld is empty, it may be checked towards whole catalogue of values for each specific sense. In Step 2, the first node 111, that is, the application portal, according to Action 302, 305 and Action 501, asks if the request of the previous step is valid towards the sense database. This is done by sending the fourth indication to the third node 113. The fourth indication is a Test Sense generator request (Get Test,

SenseType=smell/touch optional=SenseContentld). Continuing in panel b), in Step 3, the sense database may provide a URL where the sense requested in Step 1 may be tested, based on the (SenseType SenseContentld) selected by the device 130. The URL is provided by sending, in accordance with Action 502 and Action 306, the fifth indication to the first node 111 as a Test Sense generator response (Get Test, SenseType=smell/touch optional=SenseContentld url=http://TestSenseGenerator). In Step 4, in accordance with Action 307 and Action 402, the first node 111 sends the eighth indication towards the device (130), as a Test Sense generator response (Get Test, SenseType=smell/touch optional=SenseContentld url=http://TestSenseGenerator). In Step 5, depending on if the sense generator is in the device 130, the device 130, according to Action 403, initiates providing the content towards the user of the device 130 by connecting directly to the URL that contains this sense test at the sixth node 116, or, continuing on panel c), uses it using the fourth node 114 as sense generator, in Step 6, connected via Bluetooth, in accordance with Actions 403 and Action 404. The sense generator may be another physical entity or it may be integrated in the device 130. In this example, the fourth node 114 is a scent generator. The device 130 may know which type of sense generator the fourth node 114 may be. In Step 7, according to Action 403 and Action 405, the device 130 may, request a test sense by sending the eleventh indication to the sixth node 116, the test URL provider, as a Perform test (url=http://TestSenseGenerator). In Step 8, the test URL provider may, according to Action 503, request from the third node 113 the corresponding sense as a Get Sense (url=http://TestSenseGenerator). According to Action 504, the third node 113 may provide the fifteenth indication to the sixth node 116. In Step 9, according to Action 406, the content may then be sent towards the device 130 as a sense test.

FIG. 8 is a signalling diagram depicting a second non-limiting example of another method performed in the communications system 100, according to embodiments herein, over panels a), b), c), d), e) and f). The use case example of FIG. 8 depicts an example of a second group of embodiments, wherein a doctor may perform a test sense, checking from his/her hospital if one of his/her patients has any illness related with smell or touch. Particularly, in this example, the communications system 100 includes a test platform comprising the following functional elements: a Front End test server as the sixth node 116, which may be responsible for handling requests that go towards the third node 113 as a sense database and communicate with other nodes/network functions, the third node 113 as the sense database, and optionally, an eighth node 118 as a results database, which may store results of the different tests if it may be needed. In this example, the third node 113 is a sense database that contains a catalog with different senses that may be tested, and which may comprise all the sense content to perform the test. In this example, the second node 112 is the AF of the doctor. Starting on panel a), the device 130 may initially authenticate over the application portal of an operator. In Step 1, the AF of the doctor may request, according to Action 301 and Action 401, the first node 111, in this example the NEF of an MNO, to perform a sense test. In this example, this may be performed by the second node 112 sending the first indication to the first node 111 specifying as sense smell and specific content: rose. He/She may ask for all sense content or a list of specific sense content. In this example, the first indication is a Nnef Sense Detector Subscribe Request (Sense=Smell, SenseContentId=Rose UE-ID). In Step 2, the first node 111, that is, the NEF, according to Action 302 and Action 303, may validate towards the fifth node 115 as UDR, if this user has provided consent for this type of request. This may be performed by sending a Nudm Consent Request (UE-ID). In Step 3, the fifth node 115 as UDR may, according to Action 304, validate the previous request by sending the third indication as a Nudm Consent Response (200 OK). Continuing on panel b), in Step 4, the first node 111 may, according to Action 305, send the fourth indication to the third node 113. This is performed indirectly in this example, by asking the sixth node 116 as a front end, for the specific test requested by the doctor, sending a Test Sense generator Subscribe Request (SenseType=smell SenseContentId=Rose UE-ID. In Step 5, the Front End may, according to Action 501, ask the sense database for an URL where the sense requested in Step 1 may be tested. This may be performed by sending the fourth indication to the third node 113 as a Test Sense generator Request (SenseType=smell SenseContentid=RoseUE-ID). In Step 6, the sense database may provide the corresponding URL to identify the sense by, according to Action 502, sending a Test Sense generator Subscribe Response (SenseType=smell SenseContentId=Rose url=http://TestSense: smell.RoseUEID)) to the sixth node 116. Continuing on panel c), in Step 7, according to Action 306, the first node 111 may obtain, indirectly, from the third node 113, the fifth indication indicating the requested location. The third node 113 may provide a URL with the set of sense needed based on (SenseType, SenseContentid) selected by the Doctor.

Then, this may be sent to the first node 111 by the Front end sending to the first node 111 the corresponding URL to be sent to device 130 and the Doctor. The fifth indication may be sent as a Test Sense generator Subscribe Response (SenseType=smell SenseContentId=Rose url=http://TestSense: smell.RoseUEID)). In Step 8, the first node 111 may send to the seventh node 117 as UPF, the corresponding URL to be sent to the device 130. This may be performed by, according to Action 307, sending the eighth indication as a Nupf SendSense (SenseType=smell SenseContentid=Rose.url=http://TestSense: smell. RoseUEID UE-ID). Continuing on panel d), in Step 9, according to Action 307 and Action 402, the first node 111, may send the answer to Step 1, to the second node 112, including the URL with the sense that is going to be tested. This may enable the doctor to check later with his/her own device which smell may be generated accessing the URL provided. This may enable the doctor to check which sense may have been sent to his/her patient. The doctor may check the test with a sense generator. In this example, the eighth indication is a Nnef SenseDetector Response (200 OK, url=http://TestSense: smell. RoseUEID). The doctor may thereby be enabled to confirm the same test provided to the end user. The doctor may only need to access the URL provided in the answer in the same way as the end user may do in Step 12. It may be noted that Step 8 and Step 9 have been depicted in this order but they may be performed in different order. In Step 10, the seventh node 117 as UPF may send the device 130 a request to test the sense. The seventh node 117 may perform this by, in accordance to Action 601, sending the eighth indication as a Nue SendSense (SenseType=smell SenseContentId=Rose, url=http://TestSense: smell.RoseUEID). Continuing on panel e), in Step 11, depending on whether the fourth node 114 as sense generator may be in the device 130, the device 130 may connect directly to the URL that may contain this sense test or use it using a sense generator connected via Bluetooth, according to Action 602 and Action 603. As stated earlier, the fourth node 114 may be another physical entity or integrated in the device 130. In this example, the fourth node 114 is a scent generator. The device 130 may know which type of sense generator the fourth node 114 may be. In Step 12, the device 130, in accordance with Action 604, using the URL provided in Step 10 may ask the sixth node 116 as Front end to perform a test. This may be performed by sending the eleventh indication as a Perform test (url=http://TestSense: smell.RoseUEID) to the sixth node 116. In Step 13, the sixth node 116 as Front End, may send the fifteenth indication in accordance with Action 503 and Action 504 to the third node 113 as a Get Sense (url=http://TestSense: smell.RoseUEID) and, in response, may get the sense information according to the URL from the sense database. Continuing on panel f), in Step 14, in accordance with Action 605, the sixth node 116 as Front end may send the sense information to the device 130. It may also ask about what the end user 130 may be able to smell in their test. This may be performed by sending the twelfth indication as a Sense test (Smell=Rose) (What can you smell?). In Step 15, the end user of the device 130, in accordance with Action 606, provides feedback about the result of their test. The end user may provide the smell of the test towards the front end by the device 130 sending the thirteenth indication as a Provide results (Smell=Rose (OK)) (Smell=Garlic (NOT OK)). In Step 16, as an optional step, the test platform may store the results of the test so they may be later checked by the doctor. The doctor may ask later the front end for the results of this user. This is not depicted here. In Step 17, the front end may notify the first node 111 the results of the tests by sending the ninth indication in accordance with Action 308. The ninth indication may be a TestSenseGenerator Notify (SenseType=smell SenseContentId=Rose UE-ID Results). In Step 18, the first node 111 may notify the doctor about the results of the test by, in accordance with Action 309 and Action 408 sending the tenth indication to the second node 112 as a TestSense generator Notify (SenseType=smell SenseContentId=Rose UE-ID Results).

Certain embodiments disclosed herein may provide one or more of the following technical advantage(s), which may be summarized as follows.

Embodiments herein may be understood to enable the device 130, e.g., a UE, to test its sense generator. Another advantage of embodiments herein may be understood to be that doctors may be able to test sense in end users using telemedicine. Yet another advantage of embodiments herein may be understood to be that a content provider may be able to tune its content according to a sensitivity of the sense generator of the end user.

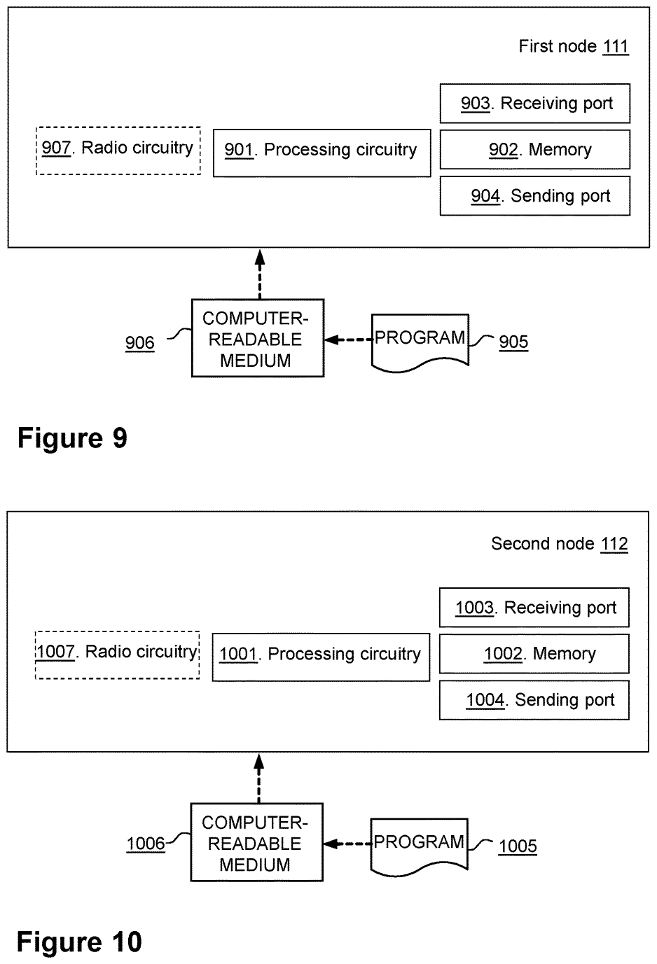

FIG. 9 depicts an example of the arrangement that the first node 111 may comprise to perform the method described in FIG. 3 and/or FIGS. 7-8. The first node 111 may be understood to be for handling the provision of the content towards the user. The first node 111 is configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, some of the indications may be configured to comprise the third identifier of the device 130, e.g., a UE-ID.

The first node 111 is configured to obtain the first indication from the second node 112 configured to operate via the communications system 100. The first indication is configured to indicate the request to provide the location of the content for delivery to the user of the device 130 configured to operate in the communications system 100. The content is configured to be comprised in the third node 113 configured to be accessible via the communications system 100. The content is configured to provide the stimulus of the sense, configured to be catalogued as such in the third node 113, to the user of the device 130.

The first node 111 is also configured to initiate, responsive to the obtained first indication, providing the content towards the user of the device 130 via the fourth node 114. In some embodiments, the first indication may be configured to comprise at least one of: a) the first identifier of type of sense, and b) the second identifier of the content.

In some embodiments, the initiating providing may be configured to further comprise to send, based on the obtained first indication, the second indication to the fifth node 115 configured to operate in the communications system 100. The second indication may be configured to request whether or not the second node 112 may have consent to submit the request.

In some embodiments, the initiating providing may be configured to further comprise to receive the third indication from the fifth node 115 in response to the second indication configured to be sent. The third indication may be configured to indicate whether or not the second node 112 may have consent to submit the request.

In some embodiments, the initiating providing may be further configured to comprise to send, directly or indirectly, based on the first indication configured to be received, the fourth indication to the third node 113. The fourth indication may be configured to indicate the request to provide the location of the content for delivery.

In some embodiments, the initiating providing may be further configured to comprise to obtain, directly or indirectly, in response to the fourth indication configured to be sent, the fifth indication from the third node 113. The fifth indication may be configured to indicate the location configured to be requested.

In some embodiments, the initiating providing may be further configured to comprise to send, directly or indirectly, the eighth indication towards at least one of: the device 130 and the second node 112. The eighth indication may be configured to indicate the obtained location configured to be requested.

In some embodiments, the fourth indication may be configured to be sent via the sixth node 116, wherein the sixth node 116 may be configured to be the front end test server, and the fifth indication may be configured to be received via the sixth node 116.

In some embodiments wherein the request to provide the location of the content for delivery may be to perform the test on the content, the first node 111 may be further configured to comprise to receive, based on the first indication configured to be obtained, the ninth indication from the sixth node 116. The ninth indication may be configured to indicate the result of the test.

In some embodiments wherein the request to provide the location of the content for delivery may be to perform the test on the content, the first node 111 may be further configured to comprise to initiate sending, responsive to the ninth indication configured to be received, the tenth indication to the second node 112. The tenth indication may be configured to indicate the result of the test.

In some embodiments, the third node 113 may be configured to be the sense database, the fourth node 114 may be configured to be the sense generator, and one of the following may apply: a) the first node 111 may be configured to be the AS, and the second node 112 may be configured to be the device 130, and b) the first node 111 may be configured to be the NEF and the second node 112 may be configured to be the AF.

In some embodiments, at least one of the following may apply: a) the fourth node 114 may be configured to be controlled by the device 130, b) the sense may be configured to be one of olfaction and touch, c) the request to provide the location of the content for delivery may be configured to be to perform the test on the content, d) the test may be configured to be the calibration of the one of the fourth node 114 and the content, e) the location may be configured to be the URL, and f) the communications system 100 may be configured to be a 5G network.

The embodiments herein in the first node 111 may be implemented through one or more processors, such as a processing circuitry 901 in the first node 111 depicted in FIG. 9, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 902 comprising one or more memory units. The memory 902 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, the sixth node 116, the seventh node 117, the eighth node 118, the radio network node 140, the device 130, another node, and/or another structure in the communications system 100, through a receiving port 903. In some embodiments, the receiving port 903 may be, for example, connected to one or more antennas in first node 111. In other embodiments, the first node 111 may receive information from another structure in the communications system 100 through the receiving port 903. Since the receiving port 903 may be in communication with the processing circuitry 901, the receiving port 903 may then send the received information to the processing circuitry 901. The receiving port 903 may also be configured to receive other information.

The processing circuitry 901 in the first node 111 may be further configured to transmit or send information to e.g., the second node 112, the third node 113, the fourth node 114, the fifth node 115, the sixth node 116, the seventh node 117, the eighth node 118, the radio network node 140, the device 130, another node, and/or another structure in the communications system 100, through a sending port 904, which may be in communication with the processing circuitry 901, and the memory 902.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 901, perform as described above. One or more of these processors, as well as the other digital hardware, may be included in a single

Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 901.

Thus, the methods according to the embodiments described herein for the first node 111 may be respectively implemented by means of a computer program 905 product, comprising instructions, i.e., software code portions, which, when executed on at least one processing circuitry 901, cause the at least one processing circuitry 901 to carry out the actions described herein, as performed by the first node 111. The computer program 905 product may be stored on a computer-readable storage medium 906. The computer-readable storage medium 906, having stored thereon the computer program 905, may comprise instructions which, when executed on at least one processing circuitry 901, cause the at least one processing circuitry 901 to carry out the actions described herein, as performed by the first node 111. In some embodiments, the computer-readable storage medium 906 may be a non-transitory computer-readable storage medium, such as a CD ROM disc, or a memory stick. In other embodiments, the computer program 905 product may be stored on a carrier containing the computer program 905 just described, wherein the carrier is one of an electronic signal, optical signal, radio signal, or the computer-readable storage medium 906, as described above.

The first node 111 may comprise a communication interface configured to facilitate, or an interface unit to facilitate, communications between the first node 111 and other nodes or devices, e.g., the second node 112, the third node 113, the fourth node 114, the fifth node 115, the sixth node 116, the seventh node 117, the eighth node 118, the radio network node 140, the device 130, another node, and/or another structure in the communications system 100. The interface may, for example, include a transceiver configured to transmit and receive radio signals over an air interface in accordance with a suitable standard.

In other embodiments, the first node 111 may comprise a radio circuitry 907, which may comprise e.g., the receiving port 903 and the sending port 904.

The radio circuitry 907 may be configured to set up and maintain at least a wireless connection with the second node 112, the third node 113, the fourth node 114, the fifth node 115, the sixth node 116, the seventh node 117, the eighth node 118, the radio network node 140, the device 130, another node, and/or another structure in the communications system 100. Circuitry may be understood herein as a hardware component.

Hence, embodiments herein also relate to the first node 111 operative to operate in the communications system 100. The first node 111 may comprise the processing circuitry 901 and the memory 902, said memory 902 containing instructions executable by said processing circuitry 901, whereby the first node 111 is further operative to perform the actions described herein in relation to the first node 111, e.g., in FIG. 3 and/or FIGS. 7-8.

FIG. 10 depicts an example of the arrangement that the second node 112 may comprise to perform the method described in FIG. 4 and/or FIGS. 7-8. The second node 112 may be understood to be for handling the provision of the content towards the user. The second node 112 is configured to operate via the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 111 and will thus not be repeated here. For example, in some embodiments, some of the indications may be configured to comprise the third identifier of the device 130, e.g., a UE-ID.

The second node 112 is configured to send the first indication to the first node 111 configured to operate in the communications system 100. The first indication is configured to indicate the request to provide the location of the content for delivery towards the user of the device 130 configured to operate in the communications system 100. The content is configured to be comprised in the third node 113 configured to be accessible via the communications system 100. The content is configured to provide the stimulus of the sense, configured to be catalogued as such in the third node 113, to the user of the device 130.

The second node 112 is also configured to receive, responsive to the first indication configured to be sent, directly or indirectly, the eighth indication from the first node 111. The eighth indication is configured to indicate the location configured to be requested.

In some embodiments, the first indication may be configured to comprise at least one of: a) the first identifier of type of sense, and b) the second identifier of the content.

In some embodiments, the initiating providing may be configured to further comprise to initiate, responsive to the received eighth indication, providing the content towards the user of the device 130 via the fourth node 114.

In some embodiments, the initiating providing may be configured to further comprise to initiate connection to the fourth node 114.

In some embodiments, the initiating providing may be configured to further comprise to send the eleventh indication to the sixth node 116 configured to operate via the communications system 100. The eleventh indication may be configured to indicate the location configured to be requested.

In some embodiments, the initiating providing may be configured to further comprise to receive the twelfth indication from the sixth node 116. The twelfth indication may be configured to comprise the content.

In some embodiments, optionally, the initiating providing may be configured to further comprise to provide the thirteenth indication configured to indicate the sensation caused by delivery of the content towards the user of the device 130.

In some embodiments, the third node 113 may be configured to be the sense database, the fourth node 114 may be configured to be the sense generator, and one of the following may apply: a) the first node 111 may be configured to be the AS, and the second node 112 may be configured to be the device 130, and b) the first node 111 may be configured to be the NEF and the second node 112 may be configured to be the AF.

In some embodiments, the request to provide the location of the content for delivery may be configured to be to perform the test on the content, and the second node 112 may be further configured to receive, responsive to the first indication configured to be sent, the tenth indication from the first node 111. The tenth indication may be configured to indicate the result of the test.

In some embodiments, at least one of the following may apply: a) the fourth node 114 may be configured to be controlled by the device 130, b) the sense may be configured to be one of olfaction and touch, c) the request to provide the location of the content for delivery may be configured to be to perform the test on the content, d) the test may be configured to be the calibration of one of the fourth node 114 and the content, e) the location may be configured to be the URL, and f) the communications system 100 may be configured to be a 5G network.

The embodiments herein in the second node 112 may be implemented through one or more processors, such as a processing circuitry 1001 in the second node 112 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1002 comprising one or more memory units. The memory 1002 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, the fifth node 115, the sixth node 116, the seventh node 117, the eighth node 118, the radio network node 140, the device 130, another node, and/or another structure in the communications system 100, through a receiving port 1003. In some embodiments, the receiving port 1003 may be, for example, connected to one or more antennas in second node 112. In other embodiments, the second node 112 may receive information from another structure in the communications system 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the second node 112 may be further configured to transmit or send information to e.g., the first node 111, the third node 113, the fourth node 114, the fifth node 115, the sixth node 116, the seventh node 117, the eighth node 118, the radio network node 140, the device 130, another node, and/or another structure in the communications system 100, through a sending port 1004, which may be in communication with the processing circuitry 1001, and the memory 1002.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 1001.

Thus, the methods according to the embodiments described herein for the second node 112 may be respectively implemented by means of a computer program 1005 product, comprising instructions, i.e., software code portions, which, when executed on at least one processing circuitry 1001, cause the at least one processing circuitry 1001 to carry out the actions described herein, as performed by the second node 112. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the second node 112. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The second node 112 may comprise a communication interface configured to facilitate, or an interface unit to facilitate, communications between the second node 112 and other nodes or devices, e.g., the first node 111, the third node 113, the fourth node 114, the fifth node 115, the sixth node 116, the seventh node 117, the eighth node 118, the radio network node 140, the device 130, another node, and/or another structure in the communications system 100. The interface may, for example, include a transceiver configured to transmit and receive radio signals over an air interface in accordance with a suitable standard.

In other embodiments, the second node 112 may comprise a radio circuitry 1007, which may comprise e.g., the receiving port 1003 and the sending port 1004.

The radio circuitry 1007 may be configured to set up and maintain at least a wireless connection with the first node 111, the third node 113, the fourth node 114, the fifth node 115, the sixth node 116, the seventh node 117, the eighth node 118, the radio network node 140, the device 130, another node, and/or another structure in the communications system 100.

Circuitry may be understood herein as a hardware component.

Hence, embodiments herein also relate to the second node 112, operative to operate in the communications system 100. The second node 112 may comprise the processing circuitry 1001 and the memory 1002, said memory 1002 containing instructions executable by said processing circuitry 1001, whereby the second node 112 is further operative to perform the actions described herein in relation to the second node 112, e.g., in FIG. 4 and/or FIGS. 7-8.

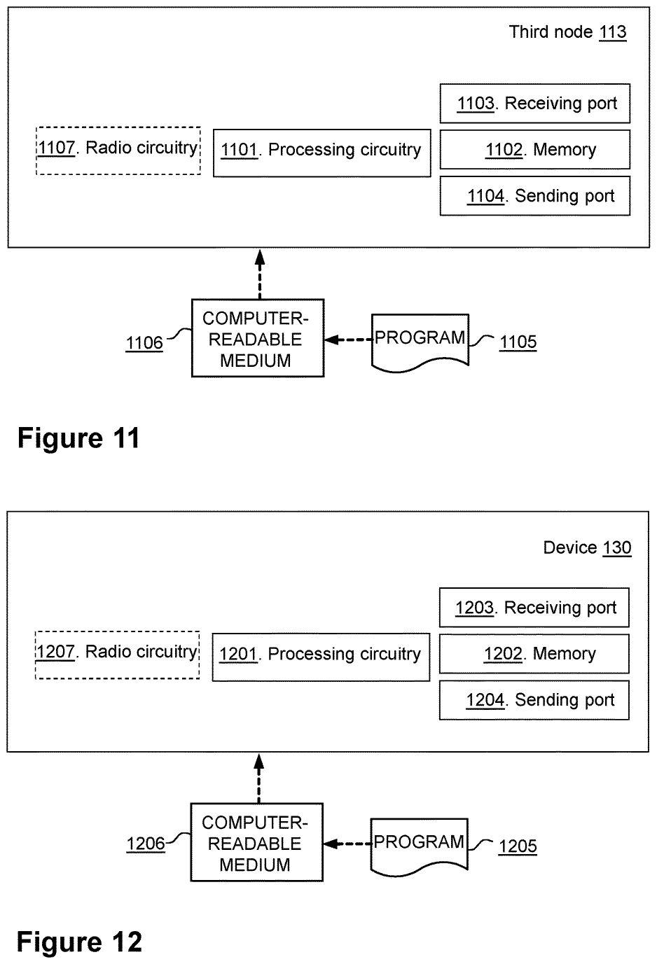

FIG. 11 depicts an example of the arrangement that the third node 113 may comprise to perform the method described in FIG. 5 and/or FIGS. 7-8. The third node 113 is configured to be accessible via the communications system 100. The third node 113 may be understood to be for handling the provision of the content towards the user.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the third node 113 and will thus not be repeated here. For example, in some embodiments, some of the indications may be configured to comprise the third identifier of the device 130, e.g., a UE-ID.

The third node 113 is configured to receive, directly or indirectly, the fourth indication from the first node 111 configured to operate in the communications system 100. The fourth indication is configured to indicate the request to provide the location of the content for delivery towards the user of the device 130 configured to operate in the communications system 100. The content is configured to be comprised in the third node 113. The content is configured to provide the stimulus of the sense, catalogued as such in the third node 113, to the user of the device 130.

The third node 113 is also configured to provide, directly or indirectly, in response to the fourth indication configured to be received, the fifth indication to the first node 111. The fifth indication is configured to indicate the location configured to be requested.

In some embodiments, the fourth indication may be configured to comprise at least one of: a) the first identifier of type of sense, and b) the second identifier of the content.

In some embodiments, i) the fourth indication may be configured to be received via the sixth node 116, wherein the sixth node 116 may be configured to be the front end test server, and ii) the fifth indication may be configured to be provided via the sixth node 116.

In some embodiments, the third node 113 may be further configured to receive, based on the fifth indication configured to be sent, the fourteenth indication from the sixth node 116. The fourteenth indication may be configured to request the content.

In some embodiments, the third node 113 may be further configured to provide, responsive to the fourteenth indication configured to be received, the fifteenth indication to the sixth node 116. The fifteenth indication may be configured to indicate the content.

In some embodiments, at least one of the following may apply: a) the content may be configured to provide the stimulus of the sense to the user of the device 130 via the fourth node 114, b) the fourth node 114 may be configured to be controlled by the device 130, c) the sense may be configured to be one of olfaction and touch, d) the request to provide the location of the content for delivery may be configured to be to perform the test on the content, e) the test may be configured to be the calibration of one of the fourth node 114 and the content, f) the location may be configured to be the URL, and g) the communications system 100 may be configured to be a 5G network.

In some embodiments, the third node 113 may be configured to be the sense database, the fourth node 114 may be configured to be the sense generator, and one of the following may apply: a) the first node 111 may be configured to be the AS, and b) the first node 111 may be configured to be the NEF.

In some embodiments, the third node 113 may be configured to be the sense database, the fourth node 114 may be configured to be the sense generator, and one of the following may apply: a) the first node 111 may be configured to be the AS, and the second node 112 may be configured to be the device 130, and b) the first node 111 may be configured to be the NEF and the second node 112 may be configured to be the AF.

The embodiments herein in the third node 113 may be implemented through one or more processors, such as a processing circuitry 1101 in the third node 113 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1102 comprising one or more memory units. The memory 1102 is arranged to be used to store obtained information, store data, configurations, schedulings, and applications etc. to perform the methods herein when being executed in the third node 113.

In some embodiments, the third node 113 may receive information from, e.g., the first node 111, the second node 112, the fourth node 114, the fifth node 115, the sixth node 116, the seventh node 117, the eighth node 118, the radio network node 140, the device 130, another node, and/or another structure in the communications system 100, through a receiving port 1103. In some embodiments, the receiving port 1103 may be, for example, connected to one or more antennas in third node 113. In other embodiments, the third node 113 may receive information from another structure in the communications system 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the third node 113 may be further configured to transmit or send information to e.g., the first node 111, the second node 112, the fourth node 114, the fifth node 115, the sixth node 116, the seventh node 117, the eighth node 118, the radio network node 140, the device 130, another node, and/or another structure in the communications system 100, through a sending port 1104, which may be in communication with the processing circuitry 1101, and the memory 1102.

Those skilled in the art will also appreciate that the units comprised within the third node 113 described above as being configured to perform different actions, may refer to a combination of analog and digital circuits, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the third node 113 described above as being configured to perform different actions described above may be implemented as one or more applications running on one or more processors such as the processing circuitry 1101.

Thus, the methods according to the embodiments described herein for the third node 113 may be respectively implemented by means of a computer program 1105 product, comprising instructions, i.e., software code portions, which, when executed on at least one processing circuitry 1101, cause the at least one processing circuitry 1101 to carry out the actions described herein, as performed by the third node 113. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the third node 113. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The third node 113 may comprise a communication interface configured to facilitate, or an interface unit to facilitate, communications between the third node 113 and other nodes or devices, e.g., the first node 111, the second node 112, the fourth node 114, the fifth node 115, the sixth node 116, the seventh node 117, the eighth node 118, the radio network node 140, the device 130, another node, and/or another structure in the communications system 100. The interface may, for example, include a transceiver configured to transmit and receive radio signals over an air interface in accordance with a suitable standard.

In other embodiments, the third node 113 may comprise a radio circuitry 1107, which may comprise e.g., the receiving port 1103 and the sending port 1104.

The radio circuitry 1107 may be configured to set up and maintain at least a wireless connection with the first node 111, the second node 112, the fourth node 114, the fifth node 115, the sixth node 116, the seventh node 117, the eighth node 118, the radio network node 140, the device 130, another node, and/or another structure in the communications system 100. Circuitry may be understood herein as a hardware component.

Hence, embodiments herein also relate to the third node 113, operative to operate in the communications system 100. The third node 113 may comprise the processing circuitry 1001 and the memory 1002, said memory 1002 containing instructions executable by said processing circuitry 1001, whereby the third node 113 is further operative to perform the actions described herein in relation to the third node 113, e.g., in FIG. 5 and/or FIGS. 7-8.

FIG. 12 depicts an example of the arrangement that the device 130 may comprise to perform the method described in FIG. 6 and/or FIGS. 7-8. The device 130 may be understood to be for handling the provision of the content towards the user. The device 130 is configured to operate via the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the device 130 and will thus not be repeated here. For example, in some embodiments, some of the indications may be configured to comprise the third identifier of the device 130, e.g., a UE-ID.

The device 130 is configured to receive, directly or indirectly, the eighth indication from the first node 111 configured to operate in the communications system 100. The eighth indication is configured to indicate the location of the content for delivery towards the user of the device 130. The content is configured to be comprised in the third node 113 configured to be accessible via the communications system 100. The content is configured to provide the stimulus of the sense, configured to be catalogued as such in the third node 113, to the user of the device 130.

The device 130 is also configured to initiate, responsive to the eighth indication configured to be received, providing the content towards the user of the device 130 via the fourth node 114.

In some embodiments, the eighth indication may be configured to comprise at least one of: a) the first identifier of type of sense, and b) the second identifier of the content.

In some embodiments, the initiating providing may be configured to further comprise to initiate connection to the fourth node 114.

In some embodiments, the initiating providing may be further configured to comprise to send the eleventh indication to the sixth node 116 configured to operate via the communications system 100. The eleventh indication may be configured to indicate the location configured to be received.

In some embodiments, the initiating providing may be further configured to comprise to receive the twelfth indication from the sixth node 116. The twelfth indication may be configured to comprise the content.

In some embodiments, optionally, the initiating providing may be further configured to comprise to provide the thirteenth indication configured to indicate the sensation caused by delivery of the content towards the user of the device 130.

In some embodiments, the third node 113 may be configured to be the sense database and the fourth node 114 may be configured to be the sense generator.

In some embodiments, at least one of the following may apply: a) the fourth node 114 may be configured to be controlled by the device 130, b) the sense may be configured to be one of olfaction and touch, c) the location of the content for delivery may be configured to be to perform the test on the content, d) the test may be configured to be the calibration of one of the fourth node 114 and the content, e) the location may be configured to be the URL, and f) the communications system 100 may be configured to be a 5G network.

The embodiments herein in the device 130 may be implemented through one or more processors, such as a processing circuitry 1201 in the device 130 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the device 130. One such carrier may be in the form of a CD ROM disc. It is however feasible with other data carriers such as a memory stick. The computer program code may furthermore be provided as pure program code on a server and downloaded to the device 130.

The device 130 may further comprise a memory 1202 comprising one or more memory units. The memory 1202 is arranged to be used to store obtained information, store data, configurations, schedulings, and applications etc. to perform the methods herein when being executed in the device 130.

In some embodiments, the device 130 may receive information from, e.g., the first node 111, the second node 112, the third node 113, the fourth node 114, the fifth node 115, the sixth node 116, the seventh node 117, the eighth node 118, the radio network node 140, another node, and/or another structure in the communications system 100, through a receiving port 1203. In some embodiments, the receiving port 1203 may be, for example, connected to one or more antennas in device 130. In other embodiments, the device 130 may receive information from another structure in the communications system 100 through the receiving port 1203. Since the receiving port 1203 may be in communication with the processing circuitry 1201, the receiving port 1203 may then send the received information to the processing circuitry 1201. The receiving port 1203 may also be configured to receive other information.

The processing circuitry 1201 in the device 130 may be further configured to transmit or send information to e.g., the first node 111, the second node 112, the third node 113, the fourth node 114, the fifth node 115, the sixth node 116, the seventh node 117, the eighth node 118, the radio network node 140, another node, and/or another structure in the communications system 100, through a sending port 1204, which may be in communication with the processing circuitry 1201, and the memory 1202.

Those skilled in the art will also appreciate that the units comprised within the device 130 described above as being configured to perform different actions, may refer to a combination of analog and digital circuits, and/or one or more processors configured with software and/or firmware, e.g., stored in memory, that, when executed by the one or more processors such as the processing circuitry 1201, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the device 130 described above as being configured to perform different actions described above may be implemented as one or more applications running on one or more processors such as the processing circuitry 1201.

Thus, the methods according to the embodiments described herein for the device 130 may be respectively implemented by means of a computer program 1205 product, comprising instructions, i.e., software code portions, which, when executed on at least one processing circuitry 1201, cause the at least one processing circuitry 1201 to carry out the actions described herein, as performed by the device 130. The computer program 1205 product may be stored on a computer-readable storage medium 1206. The computer-readable storage medium 1206, having stored thereon the computer program 1205, may comprise instructions which, when executed on at least one processing circuitry 1201, cause the at least one processing circuitry 1201 to carry out the actions described herein, as performed by the device 130. In some embodiments, the computer-readable storage medium 1206 may be a non-transitory computer-readable storage medium, such as a CD ROM disc, or a memory stick. In other embodiments, the computer program 1205 product may be stored on a carrier containing the computer program 1205 just described, wherein the carrier is one of an electronic signal, optical signal, radio signal, or the computer-readable storage medium 1206, as described above.

The device 130 may comprise a communication interface configured to facilitate, or an interface unit to facilitate, communications between the device 130 and other nodes or devices, e.g., the first node 111, the second node 112, the third node 113, the fourth node 114, the fifth node 115, the sixth node 116, the seventh node 117, the eighth node 118, the radio network node 140, another node, and/or another structure in the communications system 100. The interface may, for example, include a transceiver configured to transmit and receive radio signals over an air interface in accordance with a suitable standard.

In other embodiments, the device 130 may comprise a radio circuitry 1207, which may comprise e.g., the receiving port 1203 and the sending port 1204.

The radio circuitry 1207 may be configured to set up and maintain at least a wireless connection with the first node 111, the second node 112, the third node 113, the fourth node 114, the fifth node 115, the sixth node 116, the seventh node 117, the eighth node 118, the radio network node 140, another node, and/or another structure in the communications system 100. Circuitry may be understood herein as a hardware component.

Hence, embodiments herein also relate to the device 130, operative to operate in the communications system 100. The device 130 may comprise the processing circuitry 1001 and the memory 1002, said memory 1002 containing instructions executable by said processing circuitry 1001, whereby the device 130 is further operative to perform the actions described herein in relation to the device 130, e.g., in FIG. 6 and/or FIGS. 7-8.

Embodiments herein may also comprise the communications system 100 comprising the first node 111 configured as described in relation to FIG. 9, a second node 112 as described in relation to FIG. 10, a third node 113 as described in relation to FIG. 11, and a device 130 as described in relation to FIG. 12.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 29.522 V17.6.0 (June 2022) “5G System; Network Exposure Function Northbound APIs; Stage 3”.

1. A computer-implemented method, performed by a first node, for handling provision of content towards a user, the first node operating in a communications system, the method comprising:
obtaining a first indication from a second node operating via the communications system, the first indication indicating a request to provide a location of the content for delivery to the user of a device operating via the communications system, the content being comprised in a third node accessible via the communications system, wherein the content being configured to provide a stimulus of a sense, catalogued as such in the third node, to the user of the device; and
initiating, responsive to the obtained first indication, providing the content towards the user of the device via a fourth node.

2. The method according to claim 1, wherein the first indication comprises at least one of:
a. a first identifier of type of sense; and
b. a second identifier of the content.

3. The method according to claim 1, wherein the initiating providing the content further comprises:
sending, based on the obtained first indication, a second indication to a fifth node operating in the communications system, the second indication requesting whether or not the second node has consent to submit the request; and
receiving a third indication from the fifth node in response to the sent second indication, the third indication indicating whether or not the second node has consent to submit the request.

4. The method according to claim 1, wherein the initiating providing further comprises:
sending, directly or indirectly, based on the received first indication, a fourth indication to the third node, the fourth indication indicating the request to provide the location of the content for delivery;
obtaining, directly or indirectly, in response to the sent fourth indication, a fifth indication from the third node, the fifth indication indicating the requested location; and
sending, directly or indirectly, an eighth indication towards at least one of:
the device and the second node, the eighth indication indicating the obtained requested location.

5. The method according to claim 4, wherein:
the fourth indication is sent via a sixth node, wherein the sixth node is a front end test server; and
the fifth indication is received via the sixth node.

6. The method according to claim 5, wherein the request to provide the location of the content for delivery is to perform a test on the content, and wherein the method further comprises:
receiving, based on the obtained first indication, a ninth indication from the sixth node, the ninth indication indicating a result of the test; and
initiating sending, responsive to the received ninth indication, a tenth indication to the second node, the tenth indication indicating the result of the test.

7. The method according to claim 1, wherein the third node is a sense database, the fourth node is a sense generator, and one of:
a. the first node is an Application Server, AS, and the second node is the device; and
b. the first node is a Network Exposure Function, NEF and the second node is an Application Function, AF.

8. The method according to claim 1, wherein at least one of:
a. the fourth node is controlled by the device;
b. the sense is one of olfaction and touch;
c. the request to provide the location of the content for delivery is to perform a test on the content;
d. the test is a calibration of one of the fourth node and the content;
e. the location is a Uniform Resource Locator; and
f. the communications system is a Fifth Generation, 5G, network.

9. A computer-implemented method, performed by a second node, for handling provision of content towards a user, the second node operating via a communications system, the method comprising:
sending a first indication to a first node operating in the communications system, the first indication indicating a request to provide a location of the content for delivery towards the user of a device operating via the communications system, the content being comprised in a third node accessible via the communications system, wherein the content is configured to provide a stimulus of a sense, catalogued as such in the third node, to the user of the device; and
receiving, responsive to the sent first indication, directly or indirectly, an eighth indication from the first node, the eighth indication indicating the requested location.

10. The method according to claim 9, wherein the first indication comprises at least one of:
a. a first identifier of type of sense; and
b. a second identifier of the content.

11. The method according to claim 9, further comprising:
initiating, responsive to the received eighth indication, providing the content towards the user of the device via a fourth node.

12. The method according to claim 11, wherein the initiating providing the content further comprises:
initiating connection to the fourth node;
sending an eleventh indication to a sixth node operating via the communications system, the eleventh indication indicating the requested location;
receiving a twelfth indication from the sixth node, the twelfth indication comprising the content; and
providing a thirteenth indication indicating a sensation caused by delivery of the content towards the user of the device.

13. The method according to claim 11, wherein the third node is a sense database, the fourth node is a sense generator, and one of:
a. the first node is an Application Server, AS, and the second node is the device; and
b. the first node is a Network Exposure Function, NEF and the second node is an Application Function, AF.

14. The method according to claim 9, wherein the request to provide the location of the content for delivery is to perform a test on the content, and wherein the method further comprises:
receiving, responsive to the sent first indication, a tenth indication from the first node, the tenth indication indicating the result of the test.

15. The method according to claim 11, wherein at least one of:
a. the fourth node is controlled by the device;
b. the sense is one of olfaction and touch;
c. the request to provide the location of the content for delivery is to perform a test on the content;
d. the test is a calibration of one of the fourth node and the content;
e. the location is a Uniform Resource Locator; and
f. the communications system is a Fifth Generation, 5G, network.

16.-26. (canceled)

27. A first node, for handling provision of content towards a user, the first node being configured to operate in a communications system, the first node being further configured to:
obtain a first indication from a second node configured to operate via the communications system, the first indication being configured to indicate a request to provide a location of the content for delivery to the user of a device configured to operate in the communications system, the content being configured to be comprised in a third node configured to be accessible via the communications system, wherein the content being configured to provide a stimulus of a sense, configured to be catalogued as such in the third node, to the user of the device; and
initiate, responsive to the obtained first indication, providing the content towards the user of the device via a fourth node.

28. The first node according to claim 27, wherein the initiating providing the content further comprises:
sending, based on the obtained first indication, a second indication to a fifth node operating in the communications system, the second indication requesting whether or not the second node has consent to submit the request; and
receiving a third indication from the fifth node in response to the sent second indication, the third indication indicating whether or not the second node has consent to submit the request.

29.-34. (canceled)

35. A second node, for handling provision of content towards a user, the second node being configured to operate via a communications system, the second node being further configured to:
send a first indication to a first node configured to operate in the communications system, the first indication being configured to indicate a request to provide a location of the content for delivery towards the user of a device configured to operate in the communications system, the content being configured to be comprised in a third node configured to be accessible via the communications system, wherein the content is configured to provide a stimulus of a sense, configured to be catalogued as such in the third node, to the user of the device; and
receive, responsive to the first indication configured to be sent, directly or indirectly, an eighth indication from the first node, the eighth indication being configured to indicate the location configured to be requested.

36. The second node according to claim 35, wherein the first indication is configured to comprise at least one of:
a. a first identifier of type of sense, and
b. a second identifier of the content.

37.-53. (canceled)

54. The method according to claim 2, wherein the initiating providing the content further comprises:
sending, based on the obtained first indication, a second indication to a fifth node operating in the communications system, the second indication requesting whether or not the second node has consent to submit the request; and
receiving a third indication from the fifth node in response to the sent second indication, the third indication indicating whether or not the second node has consent to submit the request.
